(19) United States
(12) Patent Application Publication
(10) Pub. No.: US 2026/0160924 A1
(43) Pub. Date: Jun. 11, 2026

(54) SYSTEMS AND METHODS FOR MAPPING SNOW COVER IN VARIABLE TERRAIN AND ASSESSING SPATIAL REPRESENTATIVENESS

(71) Applicants: Zhaocheng Wang, Chandler, AZ (US); Enrique Vivoni, Tempe, AZ (US); Jaya Venkatesh Jaya Baskar, Tempe, AZ (US); Maneesh Sarma Sistla Naga Sai, Tempe, AZ (US)

(72) Inventors: Zhaocheng Wang, Chandler, AZ (US); Enrique Vivoni, Tempe, AZ (US); Jaya Venkatesh Jaya Baskar, Tempe, AZ (US); Maneesh Sarma Sistla Naga Sai, Tempe, AZ (US)

(21) Appl. No.: 19/409,042

(22) Filed: Dec. 4, 2025

Related U.S. Application Data
(60) Provisional application No. 63/729,769, filed on Dec. 9, 2024.

(51) Int. Cl. G01W 1/14; G01C 11/06; G06V 20/13

(52) U.S. Cl. CPC G01W 1/14; G01C 11/06; G06V 20/13

(57) ABSTRACT

The present disclosure provides a system to generate a snow cover map of complex terrain. The system comprises a computing device configured to receive from a data source, a sequence of remote sensing data regarding an environment comprising a target area where changes have occurred and a surrounding area where different surface conditions have led to contrasting response between the target area and the surrounding area, apply a learning model to the remote sensing data to generate a map for each sequence of remote sensing data including a spatiotemporal pattern of intermittent snow cover, generate a snow-related parameter for the target area and the surrounding area based on the remote sensing data, receive ground observation data of the target area, and compare the ground observation data of the target area and the generated snow-related parameter from remote sensing data.

### CROSS REFERENCE TO RELATED APPLICATION

The present application claims the benefit of the co-pending application U.S. Provisional Patent Application No. 63/729,769, filed Dec. 9, 2024, the entire contents of which is hereby incorporated by reference.

### FIELD

The present disclosure relates to remote sensing systems for environmental monitoring, and more particularly to systems and methods for mapping snow cover in variable terrain using high-resolution satellite imagery and deep learning models to assess spatial representativeness of ground-based snow observations.

### SUMMARY

The hydrologic cycle, ecosystem functioning, and soil thermal regimes are impacted by snow cover, which plays a critical role in regulating surface energy and water balance. Intermittent snowpacks with multiple periods of snow accumulation and ablation have a larger areal coverage than those areas with a large, single seasonal snowpack (FIG. 1). In addition, regions with intermittent snowpacks, which cover a significant portion of rain-snow transition zones, are highly sensitive to climate forcing, exhibiting large spatiotemporal variations across many scales and long-term trends of increasing snow intermittence. In a warmer future climate, many seasonal snow regions may transition to intermittent or even no-snow zones.

A major challenge in studying intermittent snowpacks is the lack of suitable observations. Long-term ground snow measurements are typically sparse and mostly located at high elevation sites with deep, seasonal snowpacks, which are poorly suited for representing intermittent snow dynamics at lower elevations. Further, the highly varied distribution of snow across a landscape around the station may limit the representativeness of point data of the surrounding area. Remote sensing data, for instance from the Moderate Resolution Imaging Spectroradiometer (MODIS) sensor, can be used to study intermittent snow cover patterns and map global intermittent snow areas, but its moderate resolution (500-m) does not capture the fine-scale snow sub-grid variability. On the other hand, airborne snow mapping at high-resolution (1-m) provides insights into snowpack conditions as influenced by vegetation and topography, but their lower temporal availability of a few days each winter limits their usefulness for monitoring the seasonal evolution of snow cover dynamics.

A promising approach for mapping intermittent snow cover is using high spatiotemporal resolution CubeSat imagery. From its satellite constellation, Planet Labs has been capturing 3-m, near-daily PlanetScope (PS) imagery in the Red, Green, Blue (RGB), and Near-Infrared (NIR) bands since 2017. Recent studies have shown that PS imagery is useful for monitoring hydrologic processes that are otherwise unobservable with other remote sensing products. Furthermore, snowpack detection from CubeSat platforms is a feasible task due to the strong spectral contrast between snow and no-snow areas. Various methods have been developed for this purpose using PS imagery, including surface reflectance thresholds, random forest regression, maximum likelihood classification, and convolutional neural networks. However, the application of these products for intermittent snowpack regions are limited and further efforts are needed to improve the understanding of snow cover dynamics at these sites.

According to an aspect of the present disclosure, a system to generate a snow cover map of complex terrain is provided. The system comprises a computing device configured to receive from a data source, a sequence of remote sensing (RS) data regarding an environment comprising a target area where changes have occurred and a surrounding area where different surface conditions have led to contrasting response between the target area and the surrounding area. The computing device is configured to apply a learning model to the RS data to generate a map for each sequence of RS data including a spatiotemporal pattern of intermittent snow cover. The computing device is configured to generate a snow-related parameter for the target area and the surrounding area based on the RS data. The computing device is configured to receive ground observation data of the target area. The computing device is configured to compare the ground observation data of the target area and the generated snow-related parameter from RS data.

According to other aspects of the present disclosure, the system may include one or more of the following features. The snow-related parameter may be a spatial representativeness of snow cover. The snow-related parameter may be a snow depth. The snow-related parameter may be a soil moisture. The computing device may be further configured to generate a predicted snow melt runoff volume for the target area based on the snow-related parameter. The map may include the spatiotemporal pattern at near-daily, 3-m resolution. The RS data may include CubeSat imagery or data from an unmanned aerial vehicle, a drone, an airplane, or other satellites. The ground observation data may include Snowtography, SNOTEL, or other in-site sensors. The learning model may be a U-Net deep learning model. The computing device may be configured to assess spatial representativeness by comparing point measurements to surrounding landscape variability. The computing device may be further configured to generate snow persistence maps based on the spatiotemporal pattern of intermittent snow cover.

According to another aspect of the present disclosure, a method for generating a snow cover map of complex terrain is provided. The method comprises receiving from a data source, a sequence of remote sensing (RS) data regarding an environment comprising a target area where changes have occurred and a surrounding area where different surface conditions have led to contrasting response between the target area and the surrounding area. The method comprises applying a learning model to the RS data to generate a map for each sequence of RS data including a spatiotemporal pattern of intermittent snow cover. The method comprises generating a snow-related parameter for the target area based on the RS data. The method comprises receiving ground observation data of the target area. The method comprises comparing the ground observation data of the target area and the map of each sequence of the RS data.

According to other aspects of the present disclosure, the method may include one or more of the following features. The snow-related parameter may be a spatial representativeness of snow cover. The snow-related parameter may be either a snow depth or a soil moisture, wherein inferring snow depth provides volumetric measurements. The method may further comprise generating a predicted snow melt runoff volume for the target area based on the snow-related parameter. The map may include the spatiotemporal pattern at near-daily, 3-m resolution. The RS data may include at least one selected from a group consisting of CubeSat imagery, lidar surveys, data from an unmanned aerial vehicle, a drone, an airplane, and other satellites. The ground observation data may include at least one selected from a group consisting of Snowtography, SNOTEL, and other in-site sensors. The learning model may be a U-Net deep learning model, and the method may further comprise assessing spatial representativeness by comparing point measurements to surrounding landscape variability and generating snow persistence maps based on the spatiotemporal pattern of intermittent snow cover. The method may further comprise generating snow persistence maps based on the spatiotemporal pattern of intermittent snow cover.

In some aspects, the techniques described herein relate to a system to generate a snow cover map of complex terrain, the system including: a computing device configured to: receive from a data source, a sequence of remote sensing (RS) data regarding an environment including a target area where changes have occurred and a surrounding area where different surface conditions have led to contrasting response between the target area and the surrounding area, apply a learning model to the RS data to generate a map for each sequence of RS data including a spatiotemporal pattern of intermittent snow cover, generate a snow-related parameter for the target area and the surrounding area based on the RS data, receive ground observation data of the target area, and compare the ground observation data of the target area and the generated snow-related parameter from RS data.

In some aspects, the techniques described herein relate to a method for generating a snow cover map of complex terrain, the method including: receiving from a data source, a sequence of remote sensing (RS) data regarding an environment including a target area where changes have occurred and a surrounding area where different surface conditions have led to contrasting response between the target area and the surrounding area, applying a learning model to the RS data to generate a map for each sequence of RS data including a spatiotemporal pattern of intermittent snow cover, generating a snow-related parameter for the target area based on the RS data, receiving ground observation data of the target area, and comparing the ground observation data of the target area and the map of each sequence of the RS data.

Other aspects of the invention will become apparent by consideration of the detailed description and accompanying drawings.

### BRIEF DESCRIPTION OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a conceptual diagram of seasonal and intermittent snow regimes. Intermittent regime refers to regions with periods of no snow during the core snow season.

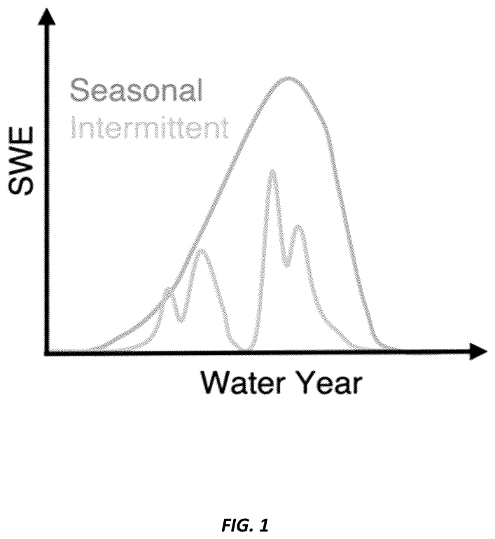

FIG. 2 illustrates the study area characteristics. (a) Locations of the SVR and BC watersheds in Arizona and their SNOTEL stations. (b) Average wet-bulb temperature (Tw, ° C.) from PRISM during the winter season (November to April) with contour lines representing elevation. (c) Average snow persistence (SP, %, 2001-2023) with SNOTEL and Snowtography stations.

FIG. 3 is a bar plot showing the areal fraction (Af, %) of the BC sub-basin with snow persistence (SP) in three categories: <5%, 5 to 20%, and >20% from water years 2001 to 2023, and the annual average from the 23-year period. Dataset is obtained from Johnston et al. (2024).

FIG. 4 illustrates the location of snow maps used in this study from: (a) Airborne Snow Observatories (ASO) and (b) University of Arizona (AZ LiDAR), overlaid with snow regime map from Johnston et al. (2024).

FIG. 5 illustrates Snowtography imagery from one site (Alley View, Table 3, #6) during four dates representing: (a) first snow event in the season, (b) first date with zero snow depth measured, (c) peak snow depth in the season, and (d) first day with no snow on ground. SD is snow depth.

FIG. 6 illustrates model performance in capturing snow distribution. (a) PS imagery Mar. 9 2019) used as model input, with black boxes indicating locations in panels (b)-(d). (b)-(d) Zoomed-in views of boxes arranged from north to south, with the RGB images (input), snow depth (SD) data (label), and model-derived snow cover (binary prediction). (e) Scatter plot of simulated (SCDSim) and observed (SCDObs) snow-covered days from six Snowtography sites across five winter seasons (2019 to 2023) in the BC watershed.

FIG. 7 illustrates deep learning model performance in capturing snow cover distribution for evaluation regions in the western U.S. and SVR basin (Table 2). A horizontal line at 0.8 serves as a benchmark for good performance. As a reference, the performance of the Snow classification from the Planet UDM is shown at each site.

FIG. 8 illustrates Snow level (SL, meters above sea level) derived from CubeSat and MODIS products in 50-m elevation bins, overlaid with SL from Snowtography (ST) sites during winters of 2021, 2022, and 2023, respectively (a)-(c). Gray shading indicates periods with no snow at Snowtography sites. Probability distribution of SL along the elevation gradient for each year and their average (d).

FIG. 9 illustrates (a) Pearson's correlation coefficients between average SCD (winter seasons of 2021 to 2023) and DEM, NI, and CHM at eight sites (Table 3), with inset showing the site elevation. (b)-(e) depict the DEM, NI, CHM, and SCD for a 1000-m area centered on site 3 (Meadow at Campground). (f)-(i). Same as (b)-(e), but for site 8 (Hutch Mountain).

FIG. 10 illustrates probability density functions (pdf) of snow-covered days (SCD) for eight ground sites (1000-m×1000-m areas around each site), categorized by all pixels (gray), north-facing slopes (blue, NI>0.1), and south-facing slopes (orange, NI<0.1). Vertical solid lines represent the median SCD in the area and the vertical dashed lines denote SCD at the ground site.

FIG. 11 illustrates characteristics of selected 1000-m×1000-m area around the site 7 (Table 3): (a) DEM, (b) NI, (c) CHM, (d) average snow-covered days (SCD) from 2021 to 2023, and two PS true color images on Apr. 13, 2023 (e) and Mar. 24, 2023 (f).

FIG. 12 illustrates (a) High-resolution (3-m) average SP from 2021 to 2023 in the BC watershed. (b) Comparison of SP between MODIS and CubeSat (aggregated to 500-m) products. (c) Average SP (<SP>) as a function of elevation in the BC watershed, with vertical bars showing bin-averaged values (100 m bins) with ±1 standard deviation. Dashed lines represent SP in north- and south-facing areas within each bin. Also shown is the elevation gradient of the Coefficient of Variation (CVSP) of SP and its spread (25% to 75% percentile) within each bin (error bars).

FIG. 13 depicts an example system that includes a computer or computing device that can be programmed or otherwise configured to implement systems or methods of the present disclosure.

FIG. 14 depicts an example environment that can be employed to execute embodiments of the present disclosure.

FIG. 15 illustrates a method for generating snow-related parameters from remote sensing data, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Mapping snow cover in areas where shallow snowpack rapidly melts is difficult. Terrain and vegetation strongly affect the snowpack on ground, creating a complex pattern of snowpack. The present disclosure provides a system and method of combining high-resolution satellite images with a machine learning model to map snow cover of an environment. In an example, the environment is the Salt and Verde River basins in Arizona. In another example, the environment is an area in the western U.S. with deeper snowpack. The model can be applied with the collected satellite images and data to understand how snow cover duration changes with elevation, slope orientation, and vegetation in different years. This approach provides a new way to monitor snow in areas where it appears and disappears quickly, improving understanding of snow patterns.

In an embodiment, high spatiotemporal resolution (3-m, near-daily) CubeSat imagery was used to train a deep learning model to map snow cover in the Salt and Verde River basins (SVR) of Arizona and one of its representative sub-basins. Due to their mid-latitude location, large regions of intermittent snow cover are present in the basins, relative to other areas in the western United States. The performance of the deep learning model was evaluated against lidar-derived snow cover maps and ground observations and then the resulting spatiotemporal patterns relative to a cloud-gap-filled MODIS product were analyzed. The snow persistence (SP) maps derived from the CubeSat imagery provided a novel approach to advancing the understanding of intermittent snowpack by increasing spatial resolution from existing 1-km to 3-m scale, allowing a more detailed evaluation of different controlling processes affecting sub-grid variability from hillslope to watershed scales.

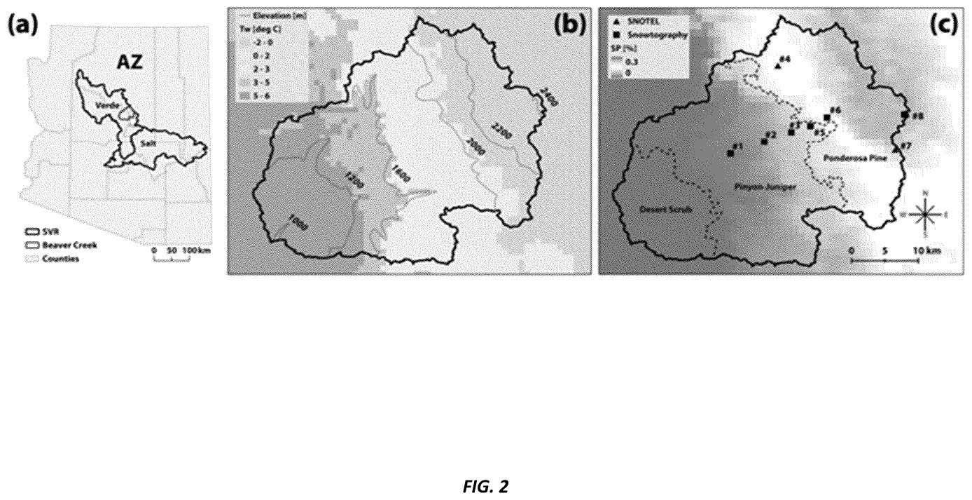

FIG. 2 illustrates an example environment that includes the Beaver Creek (BC) watershed, a large sub-basin (1100 km²) of SVR in central Arizona. BC encompasses a large elevation gradient from below 1,000 m to slightly over 2,400 m due to the Mogollon Rim, which leads to substantial climatic and snowpack variability. The average wet-bulb (Tw) temperature during the winter season (November to April) ranges from +6 to −2° C. (FIG. 2 (at b)), indicating a transition from rain- to snow-dominated precipitation regimes from lower to higher. Tw is derived from PRISM (Parameter-Elevation Regression on Independent Slope Model) normals of monthly mean air and dew point temperatures at 800 meter resolution, using the one-third approximation rule.

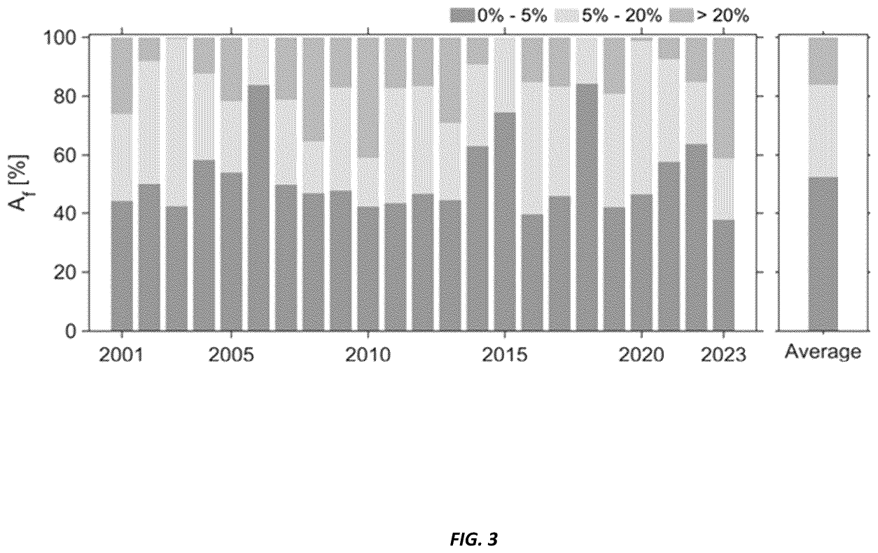

The ecosystem distribution in BC follows the elevation gradient (FIG. 2 (at c)), with desert scrub at lower elevations (<1,200 m), pinyon-juniper woodlands at mid-elevations, and ponderosa pine forests above 1,900 m. Variations in topography, climate, and vegetation strongly regulate snow persistence (SP, fraction of snow cover during a year) in the basin. Shown in FIG. 2 (at c), the long-term average SP (2001-2023) ranges from 0% at low elevations to 25% at high regions of the BC, reflecting a transition from no snow to transitional snow cover regimes. Snowpack in this region also exhibits strong interannual variability driven by large scale oceanic-atmospheric interactions. Historical records show that the areal fraction of the BC in three SP categories (<5%, 5 to 20%, and >20%) varies considerably among years (FIG. 3). Overall, the BC watershed is representative of extensive areas of intermittent snowpack with woodland and forests ecosystems in Arizona and the Southwest U.S.

### Remotely-Sensed and Ground Datasets

Several remotely sensed and ground datasets were combined as shown in Table 1.

TABLE 1
Summary of data sources used in snow cover mapping
and their associated variables, resolution, and usages.
Variables include snow depth (SD), surface reflectance
(SR), snow cover (SC, binary), snow cover fraction
(SCF), and snow water equivalent (SWE).

| Source | Variables | Resolution | Usages |
|---|---|---|---|
| Lidar | SD | 1-m | Label, Evaluation |
| PlanetScope | SR | 3-m, daily | Training Input |
| UDM | SC | 3-m, daily | Benchmark |
| MODIS | SCF | 500-m, daily | Evaluation |
| SNOTEL | SWE | Point, daily | Validation |
| Snowtography | SD | Point, daily | Validation |

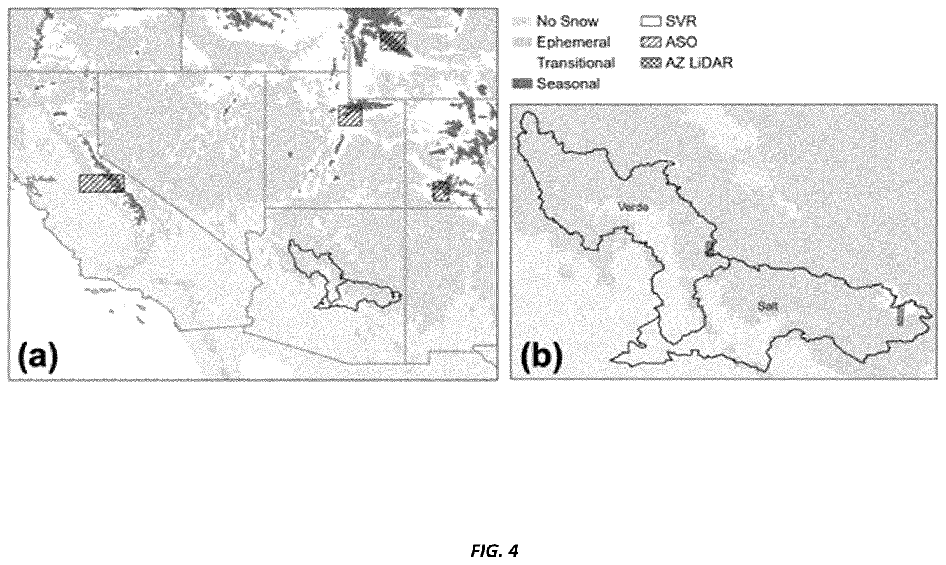

High-resolution (1-m) snow depth (SD) maps were obtained for the SVR basin in 2017 and 2019, covering two areas of ˜100 km², one in the mid-elevation Verde River and another in the high-elevation Salt River (FIG. 4). Detailed descriptions of these study areas, including spatial variations in elevation, slope, aspect, and canopy structure, are available in Broxton et al. (2019), which also described the lidar procedures. These maps capture snow conditions across a range of forest structures and topographic settings, representing both mid-winter and late-winter snow conditions. A snow depth threshold (10 cm) was used to generate a binary snow mask from the lidar snow maps. Additionally, lidar snow maps were obtained from the Airborne Snow Observatories (ASO) in Colorado, Utah, Wyoming, and California (Table 2).

TABLE 2
Snow maps from lidar used in model training and evaluation,
including acquisition date, the area of snow maps
(km²), and the fractional snow-covered area (fSCA,
%) based on a snow depth threshold of 10 cm.

| Watershed | State | Date | Area [km²] | fSCA [%] |
|---|---|---|---|---|
| Training | | | | |
| Verde | AZ | Feb. 1, 2017 | 85 | 96 |
| | | Mar. 7, 2017 | 85 | 46 |
| Evaluation | | | | |
| Animas | CO | May 16, 2021 | 2667 | 26 |
| Uinta Mountains | UT | May 16, 2024 | 1052 | 53 |
| Northern Wind River | WY | May 31, 2024 | 1163 | 64 |
| Tuolumne | CA | Apr. 30, 2021 | 1535 | 32 |
| Gunnison | CO | May 24, 2018 | 163 | 19 |
| Salt | AZ | Mar. 4, 2019 | 40 | 98 |
| Verde | AZ | Mar. 4, 2019 | 59 | 65 |

Snow regimes in these locations are mostly seasonal or transitional, whereas the SVR basin is dominated by ephemeral snow regimes (FIG. 4).

PS imagery was used for training the deep learning model and mapping snow cover dynamics. The PS imagery was acquired using constellation of CubeSats in sun-synchronous orbit. PS imagery provides R, G, B, and NIR bands at a spatial resolution of 3 meters. Merged, radiometrically-, sensor-, and geometrically-corrected surface reflectance (SR) products were used for the analysis.

### Downloading and Processing of PS Imagery

The PS imagery was requested using the Planet SDK for Python package (Version 2.0) and the command-line interface (CLI) provided by Planet. The CLI offered several functions to build a pipeline for data searching, ordering, and downloading. The PSScene asset was requested from the analytic_sr_udm2 bundle which provides 4-band Surface Reflectance and Usable Data Mask (UDM) layers. Before downloading, we utilized several tools, including clipping, merging, and harmonizing to preprocess PS imagery. A sample script used to search, filter, request, and order PS imagery is available in the GitHub repository (https://github.com/maneeshsistla8/snowcover-segmentation).

Also used, was the Usable Data Mask (UDM, Version 2.1) associated with each PS image which classifies each pixel as Clear, Cloud, Haze, Cloud Shadow, or Snow. The UDM is derived from a U-Net model using hand-labeled datasets that are geographically and temporally distributed across the globe, with a very high accuracy reported for cloud detection (F1 Score=0.95, UDM, 2024). The UDM was applied to filter PS scenes, selecting only those with less than 1% cloud cover for snow mapping. On average, there are 71 clear days in the BC watershed during the winter season, which are roughly 40% of days. Additionally, the Snow layer provided by the UDM was used as a benchmark to evaluate the deep learning model performance due to its acceptable performance across the globe (F1 Score, Precision, and Recall of 0.77, 0.78, and 0.76, respectively).

The PS imagery acquired on or near the dates when lidar snow maps were collected were selected for model training to ensure the temporal consistency between training inputs and labels.

### Cubesat Imagery and Lidar Snow Maps for Training and Testing

Two and three sets of PS imagery and snow maps from lidar surveys were used for training and testing, respectively. The Level-3B PS data was harmonized to have the same SR range as Sentinel-2. The lidar acquisition dates are listed in Table 2. In 2017, the PS acquisition date is one day earlier and two days later than the lidar mapping date, due to the availability of cloud free PS imagery. The slight offset in acquisition date has a minimum impact on the snow cover, as the snow depth change between the lidar and the PS acquisition dates are similar according to nearby ground stations. The lidar scans are both single raster tiles, of dimensions 5441×2087, covering an area of 126 km². Combined, both tiles provide over 22 million unique observations.

The trained model was then applied to map binary snow cover across the BC watershed in water years 2021 to 2023.

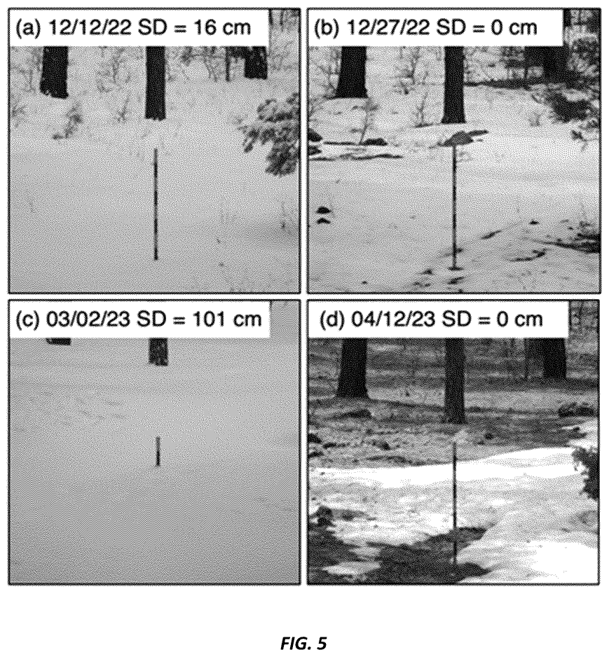

Ground observations were obtained from Snow Telemetry (SNOTEL) and Snowtography sites in the BC (FIG. 2 (at c), Table 3). Snowtography sites use trail cameras to capture images of snow depth stakes twice a day at 9:00 AM and 5:00 PM local time. The average of both times were used to represent the daily snow depth around noon. From both SNOTEL and Snowtography, a total of eight ground stations provided daily snow depth measurements across mid to high-elevation regions in the BC (1,524 to 2,438 m). Snowtography records were previously used to map snow patterns in the SVR. An example Snowtography product is shown in FIG. 5. To characterize the regional topography, a 10-meter digital elevation model (DEM) from the U.S. Geological Survey (USGS) was used. From the DEM, slope, aspect, and a northness index (NI=cos (aspect)× sin (slope)) were derived for the BC. Vegetation height was characterized using a 1-m canopy height model (CHM). The cloud gap-filled snow cover product from the MODIS Terra instrument (MOD10A1F; Hall & Riggs, 2020) was used as a coarser resolution dataset (500 m) to monitor snow level elevation. The snow cover classification regimes dataset (shown in FIG. 2 (at c)) was derived from the same MODIS product but aggregated to coarser spatial resolution of 0.01 degree (NSIDC-0791, Version 1).

TABLE 3
Ground stations with snow observations
and their elevation and network.

| No. | Station Name | Elevation [m] | Network |
|---|---|---|---|
| 1 | Apache Maid View | 1524 | Snowtography |
| 2 | Meadow at Table Mountain | 1702 | Snowtography |
| 3 | Meadow at Campground | 1888 | Snowtography |
| 4 | Bar M | 1950 | SNOTEL |
| 5 | Rattlesnake Canyon | 1975 | Snowtography |
| 6 | Alley View | 2155 | Snowtography |
| 7 | Happy Jack | 2298 | SNOTEL |
| 8 | Hutch Mountain | 2438 | Snowtography |

### Deep Learning Model for Snow Cover Mapping

A deep learning algorithm based on the U-Net architecture was employed and a transfer learning approach was used to map snow cover from PS imagery. Specifically, the ResNet-50 convolutional neural network pretrained on ImageNet available in the Torchvision package was used. Also used was the TorchGeo package to create training patches (512×512×3 matrices), split the datasets into training (80%) and testing (20%) groups, and matched input data with label datasets.

### Training of the U-Net Deep Learning Model

A transfer learning method was employed to use a pretrained convolutional neural network-based approach for the image segmentation task. A U-Net network with a ResNet-50 encoder pre-trained on ImageNet was applied. The U-Net is widely adopted in remote sensing studies to perform semantic segmentation tasks. An important feature of this network is the presence of skip connections between the encoder and decoder parts of the network that allows for learning from both high-level (coarser) and low-level (finer) features in the image. A ResNet-50 encoder is also used to extract relevant features from PS imagery efficiently using knowledge gained by transfer learning from ImageNet. Snow maps from 2017 flight were used as model input in 512×512-pixel segments of RGB along with the corresponding binary lidar snow mask. To extract these matching 512×512 patches from the data and labels, TorchGeo was used to create an Intersection Dataset, along with a GridGeoSampler to create the patches. In the transfer learning, the ResNet-50 encoder was frozen, with all the learning limited on the U-Net layers.

The model was written in PyTorch and trained on a NVIDIA A30 GPU for 200 epochs on ASU's Sol supercomputer. The Adam optimizer was used to train, with a learning rate of 10-3 for the first 100 epochs, and a learning rate of 10-4 for the final 100 epochs. Binary CrossEntropy Loss was used as the loss function.

The performance of the snow cover predictions was assessed using standard accuracy metrics for image classification and segmentation, including Precision, Recall, F1 Score, and Intersection over Union (IoU; see Text S4).

### Evaluation Metrics

Five common metrics were used to evaluate the snow classification performance: Accuracy, Precision, Recall, F1 Score, and Intersection over Union (IoU) score:

$$Accuracy = \frac{TP + TN}{TP + TN + FP + FN} , \qquad ( 1 )$$

$$Precision = \frac{TP}{TP + FP} , \qquad ( 2 )$$

$$Recall = \frac{TP}{TP + FN} , \qquad ( 3 )$$

$$F 1 Score = 2 \times \frac{Precision \times Recall}{Precision + Recall} , and \qquad ( 4 )$$

$$IoU = \frac{TP}{TP + FN + FP} , \qquad ( 5 )$$

where TP represents true positive, TN represents true negative, FP represents false positive, and FN represents false negative when comparing the model output to ground truth snow cover data. In this form, the IoU metric was used for binary classification tasks to evaluate the overlap between the ground truth and the predicted bounding boxes. As a reference, Planet Labs reported a performance of 0.77, 0.78, and 0.76 for F1 Score, Precision, and Recall, respectively, for the snow classification class in the UDM asset in their training dataset.

The model performance was evaluated using SNOTEL and Snowtography records in BC watershed, with the 3×3-pixel neighborhood centered on each site to represent snow cover from the model predictions. Furthermore, the geospatial transferability of the model was tested in other western U.S. states using ASO snow maps.

### Snow Cover Mapping Accuracy in Arizona and Western U.S.

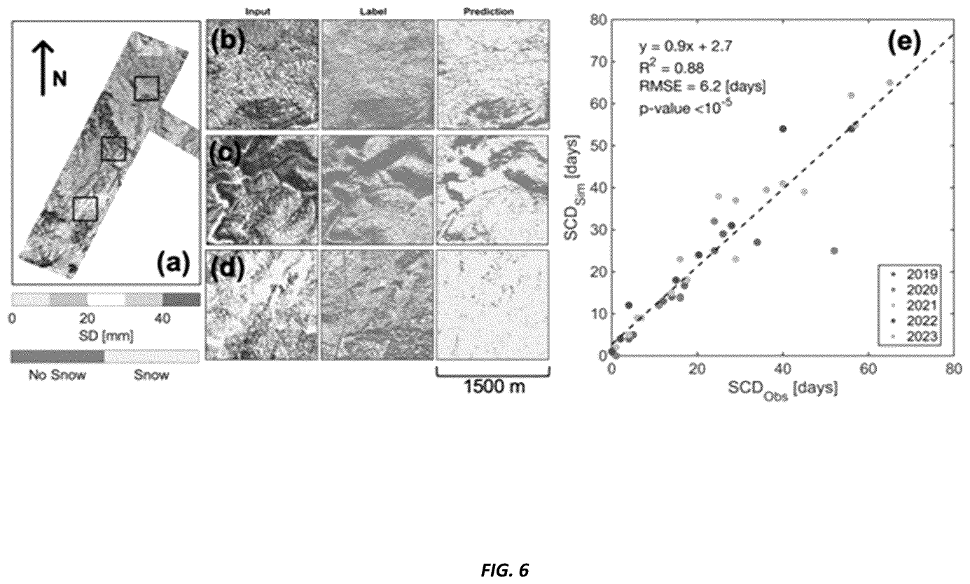

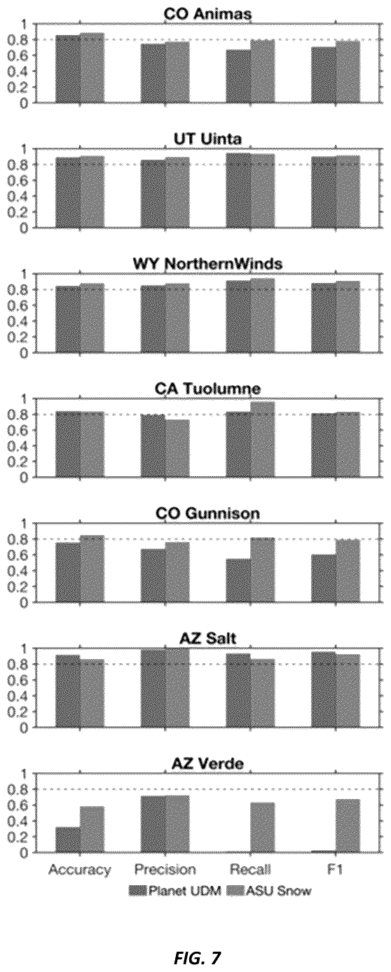

The deep learning model had strong performance in mapping snow cover across diverse conditions. Using snow maps from 2019 as the testing dataset in the SVR basin (Table 2), the model achieved a mean Accuracy, Precision, Recall, and F1 Score of 0.77, 0.79, 0.95, and 0.86, respectively. These metrics are comparable to previous studies using PS imagery. FIG. 6 shows a detailed model performance in three selected 1500-m×1500-m areas in the Verde River for 2019. Compared with the label map, the predicted snow cover had a similar spatial distribution of snow and snow-free pixels. The model performance was also evaluated temporally using daily snow observations from ground stations. FIG. 6 (at e) compares the annual total snow-covered days (SCD) from the model to six Snowtography stations in the BC watershed (Table 3) during all clear days of five winter seasons. Overall, the model showed an excellent agreement at different sites and for snow seasons that have varying SCD ranging from 0 to 60 days. The generalizability of the model was also evaluated in other regions of the western U.S. that are dominated by seasonal snowpacks (Table 2). The model maintained a stable performance with a high accuracy that consistently exceeded 0.80 (FIG. 7).

### Testing the Broader Applicability of the U-Net Model

The model trained on intermittent snow regions in the SVR effectively learned patterns of snow occurrence that also apply to seasonal snow areas, while models trained only in high-snow regions lacked the exposure to the dynamics typical of intermittent snowpacks. As a benchmark, we compared the Planet UDM Snow layer, which is also derived from a U-Net model. The UDM Snow layer achieved similar performance metrics, with F1 Score, Precision, and Recall of 0.77, 0.78, and 0.76, respectively (FIG. 7). However, the Planet UDM underperformed in the Verde River, failing to detect most snow pixels. This reflects a limitation in the UDM model ability to recognize the characteristics of intermittent snowpacks. One potential reason is that the geographic distribution of training datasets used by UDM focused on areas with seasonal and deep snowpacks. Such asymmetry in domain adaptation performance is common in machine learning. These findings underscore the importance of incorporating training samples from intermittent snow regions to improve the representativeness and adaptability of a U-Net model.

Temporal Variation in Snow Cover Revealed from CubeSats

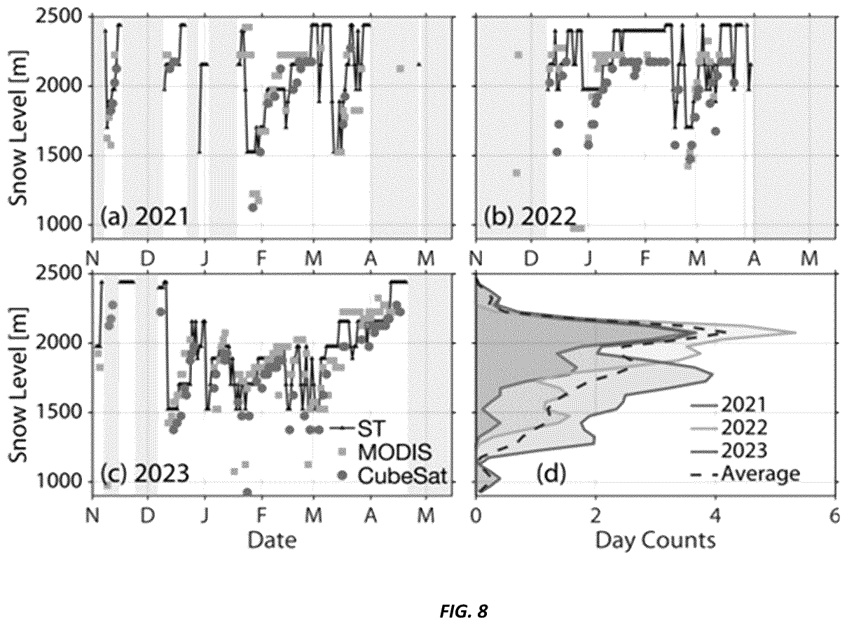

Given the model fidelity in mapping snow cover, the seasonal and interannual variability of the snow regime in the BC watershed was evaluated. The snow line (SL), or the elevation at which the rain-snow transition occurs, was used as an indicator of temporal variations. Over three winters (2021 to 2023), SL was evaluated from the CubeSat-derived snow cover maps as the lowest elevation bin (50-m) with an average snow cover fraction (SCF) exceeding 50%. SL was also derived from two datasets: (1) MODIS Snow product at daily, 500-m resolution using the same method, and (2) Daily data from the Snowtography sites using the lowest elevation with a positive SD. The derived SL time series from the three methods had similar patterns, although differences in absolute values were noted (FIG. 8).

### Comparison of Snowline Between CubeSat, MODIS and Snowtography

The CubeSat and MODIS-derived SL exhibit similar temporal patterns, with MODIS showing slightly higher elevations (1900 m versus 1817 m) due to its coarser resolution and the complex topography of the BC watershed. Despite these small differences, MODIS provided a reliable depiction of snowline variability, aligning well with CubeSat estimates. In contrast, the Snowtography-derived SL, while offering continuous ground-based data, fell short in capturing SL due to the number of limited sampling sites and the minimum elevation threshold (1500 m). In essence, the contrast between snow and no-snow regions are large enough to allow a good detection even a coarse resolution of 500-m.

The three seasons had distinct conditions, dry (2021), normal (2022), and exceptionally wet (2023), in the BC watershed. In 2021, the first snow events in early November had a SL at ˜1600 m. However, warm conditions led to rapid melting, resulting in a fast retreat of the SL to higher elevations and the complete melt of the snowpack. In contrast, the snow events in January led to a SL descending to lower elevations (˜1000 to 1500 m), where it persisted for a longer period of time especially for areas >2200 m. Similar patterns were observed in the other winter seasons, suggesting that low to mid-elevation zones (<2000 m) exhibit highly ephemeral snowpacks, whereas areas above 2200 m have more stable snowpacks. SL exhibited significant interannual variability from 2021 to 2023, as shown by its probability distribution with elevation (FIG. 8 (at d)). The average SL distribution peaks at ˜2200 m, confirming a transition in the snow regime around this elevation. For the wet year (2023), the distribution of SL exhibits two peaks at 2200 m and 1600 m, due to the frequent snow events which reset SL multiple times and prevented its retreat to higher elevations until early April. In contrast, the snowpack during the dry year (2021) failed to persist on the ground despite the occasional descents of SL to low elevations near 1,000 m. The observed snow level variability highlights the significant temporal sensitivity of intermittent snow cover.

Spatial Variation in Snow Cover Revealed from CubeSat at Local and Watershed Scales

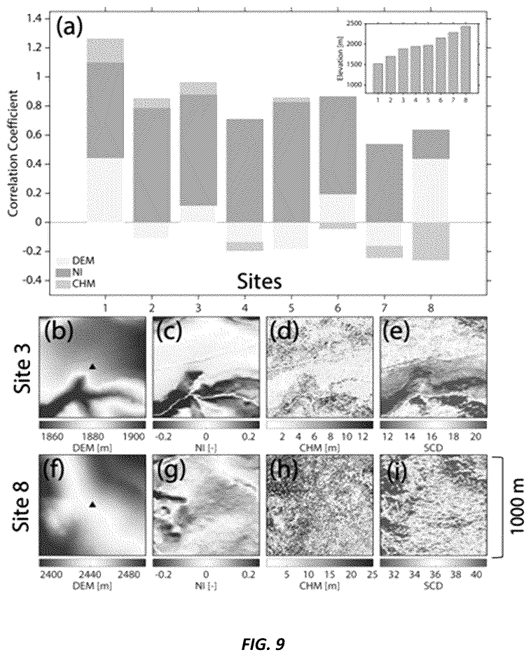

The spatial variability of intermittent snow cover is expected to be a function of topographic and vegetation attributes. To quantify these factors, we compared model-derived snow-covered days (SCD) to key attributes in the BC. FIG. 9 (at a) shows the Pearson's correlation coefficients (r) between average SCD (2021 to 2023) and elevation (DEM), northness index (NI), and canopy height model (CHM) in 1000-m×1000-m areas (333×333 pixels at 3-m) centered at the eight ground stations (Table 3). At low to mid-elevation sites (<2200 m, sites 1-6), NI was the most significant control on SCD with r>0.65 (Table 4), suggesting a dominant role in determining the spatial pattern of snowpack retention. In comparison, at high elevation sites (>2200 m), the influence of NI was lower (r=0.54 and 0.20 in site 7 and 8), while the CHM had a more pronounced correlation with SCD (r=−0.26 at site 8, highest among all sites). The negative correlation between SCD and CHM is expected as forest cover reduced snowpack through canopy sublimation.

TABLE 4
Pearson's correlation coefficient (r) between the spatial distribution
of average snow-covered days (SCD) and the physical attributes of
topography and vegetation in 1000 m × 1000 m areas centered
at each site of Table 3, including DEM, Aspect, Slope, NI, and CHM.

| No. | DEM | Aspect | Slope | NI | CHM |
|---|---|---|---|---|---|
| 1 | 0.44 | 0.21 | −0.37 | 0.66 | 0.17 |
| 2 | −0.11 | −0.27 | 0.13 | 0.79 | 0.07 |
| 3 | 0.12 | 0.14 | −0.08 | 0.76 | 0.09 |
| 4 | −0.14 | −0.48 | 0.35 | 0.71 | −0.06 |
| 5 | −0.18 | 0.55 | −0.74 | 0.83 | 0.03 |
| 6 | 0.19 | 0.18 | −0.25 | 0.67 | −0.04 |
| 7 | −0.16 | −0.38 | −0.22 | 0.54 | −0.08 |
| 8 | 0.44 | −0.21 | −0.55 | 0.20 | −0.26 |

The transition in the snow regime and its controlling factors is further illustrated using the spatial maps of the physical attributes and SCD at two representative sites (FIG. 9 (at b-i)). At site 3, located at mid-elevations, the spatial distribution of SCD closely resembles the NI map (r=0.76) with higher SCD (+7.8 days) in north-facing areas, as compared to south-facing regions (NI>+0.1 and NI<−0.1, respectively). In contrast, at site 8, the correlation of SCD with CHM increases substantially. Note the varying degrees of spatial heterogeneity present in SCD at the two sites, with smoother variations linked to NI at site 3, and finer-scale variability linked to the CHM at site 8. As a result, the local heterogeneity captured by the deep learning model and the PS imagery enables a detailed depiction of topography and forest structure effects on intermittent snow dynamics that are not discernible from coarser-resolution products such as MODIS.

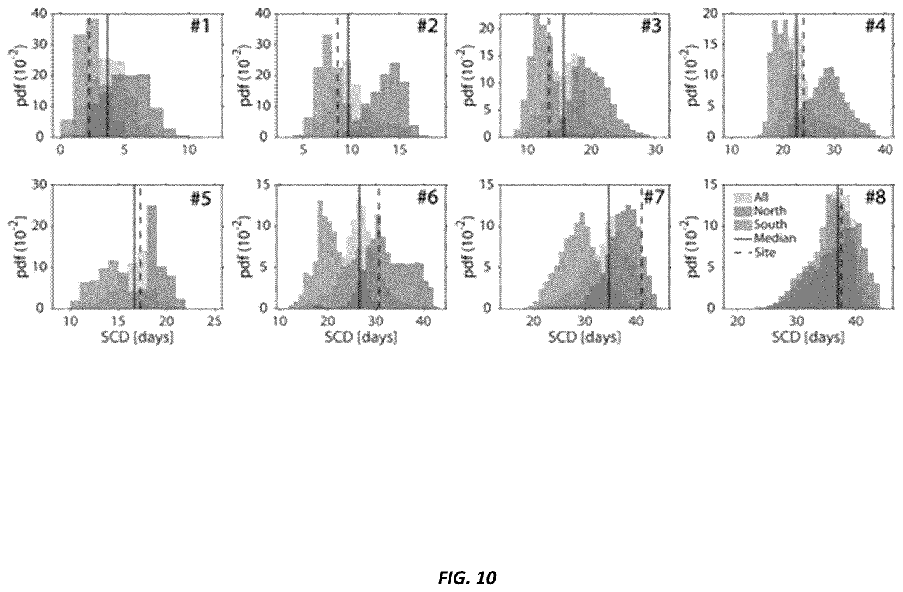

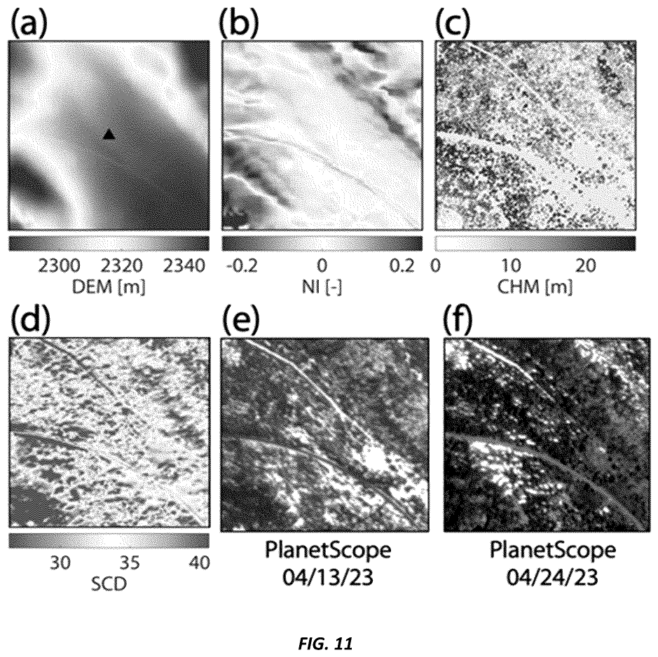

The representativeness of the ground stations in relation to the 1000-m×1000-m areas (FIG. 10 and Table 5) was also assessed. Among the eight sites, the differences in SCD between the spatial average and the point location ranged from −2.4 to +6.8 days. Notably, the high elevation site 7 (Happy Jack, 2298 m) demonstrated the largest discrepancy between the point and spatial average SCD (+6.8 days), due to its position on a flat terrain, which had a longer snow retention as compared to its surrounding area which included many south-facing locations (FIG. 11). In contrast, the differences between north-facing and south-facing locations may cancel themselves out when averaged over the 1000-m×1000-m areas, resulting in lower discrepancies between point and spatial average SCD at some sites. For instance, at the middle elevation site 4 (Bar M, 1950 m), the difference in SCD between the spatial average and point was only +0.7 days (Table 5) despite large variations in SCD with aspect (FIG. 10). The only exception is site 8 where the SCD variability is dominated by forest structure and shows no clear distinctions between north-facing and south-facing locations. Clearly, MODIS products at 500-m resolution cannot capture the shift in the influence of topographic and vegetation attributes on intermittent snow cover along the elevation gradient.

TABLE 5
Comparison of snow-covered days (SCD) in the 1000 m × 1000 m
areas around each ground station (Table 3), including the spatial
average (Average), at the center point (Point), averaged for north-
facing slopes (North), and averaged for south-facing slopes (South).
Differences are also shown (Average minus Point, North minus South).

| | SCD [days] | | | | | |
|---|---|---|---|---|---|---|
| | | | | | Average − | |
| No. | Average | Point | North | South | Point | N − S |
| 1 | 2.2 | 3.6 | 5.0 | 2.2 | −1.3 | +2.9 |
| 2 | 8.6 | 9.9 | 13.5 | 7.5 | −1.4 | +6.0 |
| 3 | 13.4 | 15.8 | 19.9 | 12.1 | −2.4 | +7.8 |
| 4 | 24.0 | 23.3 | 28.7 | 19.7 | 0.7 | +9.0 |
| 5 | 17.3 | 16.2 | 18.9 | 13.7 | 1.1 | +5.2 |
| 6 | 30.7 | 26.6 | 32.7 | 21.2 | 4.1 | +11.5 |
| 7 | 41.1 | 34.3 | 37.2 | 28.7 | 6.8 | +8.5 |
| 8 | 37.6 | 36.6 | 36.5 | 35.3 | 1.0 | +1.2 |

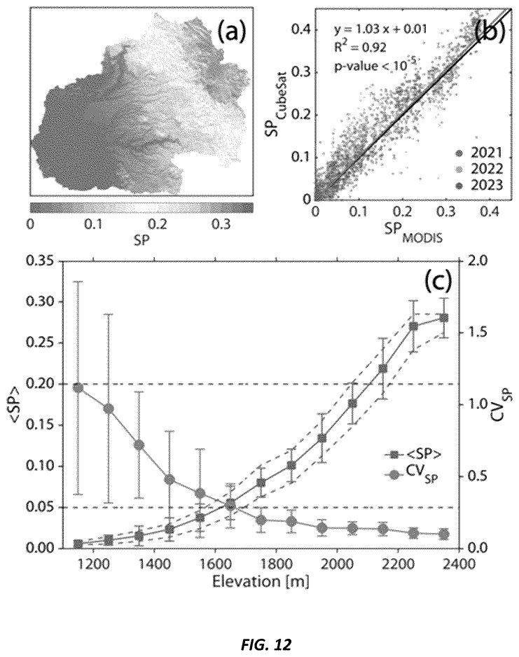

At the scale of the BC watershed, the spatial variability of snow cover dynamics was characterized by computing the snow persistence (SP) as the ratio of SCD to the number of clear-sky days during each winter season (November 1st to April 30th). When scaled to annual basis (assuming no snow cover and entirely clear skies during the rest of year), SP varies from 0 to 0.3 in the BC (FIG. 12 (at a)), with a strong relationship to elevation, consistent with the long-term MODIS SP map (FIG. 2 (at c)). The high accuracy of SP was confirmed as derived from the deep learning model and the CubeSat imagery through a validation against the MODIS-derived SP at the same spatial resolution of 1000-m in 2021 to 2023 (FIG. 12 (at b)). The variation of SP along the elevation gradient in the BC watershed exhibited a shift in the snow regime (FIG. 12 (at c)), ranging from no snow (SP<0.05), to ephemeral (0.05<SP<0.20), and to transitional snow dynamics (SP>0.20). Furthermore, north-facing sites in each elevation bin (upper dashed lines) have a significantly higher SP as compared to their nearby areas, resulting in a more seasonal snow cover regime. In contrast, south-facing sites exhibit a much lower SP than their surrounding areas and therefore more ephemeral regimes. This indicates that the snow regime at a particular site could be different than what the elevation would suggest, depending on physical attributes that are captured at high resolution from CubeSat snow maps. The sub-grid variability within each MODIS pixel along the elevation gradient was quantified by deriving the coefficient of variation (CV_{SP}=σ_{SP}/<SP>) based on the high-resolution SP values from the model (FIG. 12 (at c)). As elevation increases, <SP> rises slowly below 1600 m and then more rapidly in the 1600 to 2200 m region. Beyond 2200 m, SP is stable near 0.25. In contrast, CV_{SP} decreases with elevation from 1.0 to <0.1, reflecting the combined changes in <SP> and σ_{SP}. As a result, higher snow persistence at high elevations zones results in lower spatial variations among pixels, whereas lower SP at low elevations leads to a higher CV_{SP}. This indicates that capturing the sub-grid variability in snow cover, within a coarse-resolution product such as MODIS, is more important for intermittent snowpacks at low to mid elevations with lower snow persistence.

Recent advancement in Earth observations from CubeSat constellations have significantly enhanced the capability to study hydrologic dynamics at fine spatial and temporal scales. Here, novel observations from CubeSat imagery, lidar surveys, and ground-based Snowtography were integrated to map the spatiotemporal pattern of intermittent snow cover at near-daily, 3-m resolution. The integration occurred with the training and evaluation of a deep learning model that bridged the gap between sparse ground data and remote sensing products constrained by either low spatial or temporal resolutions. It was demonstrated that high-resolution snow cover maps provide new insights on intermittent snow regimes that cannot be resolved using coarser-scale products. While elevation serves as the dominant control on snow persistence at the watershed scale, local topographic features and vegetation structure introduce substantial sub-grid variability. Furthermore, the successful domain transferability of the deep learning model highlights its potential for snow regime classifications at 3-m resolution in broader regions, which can inform the spatial representativeness of existing ground stations and future expansions in snow observation stations.

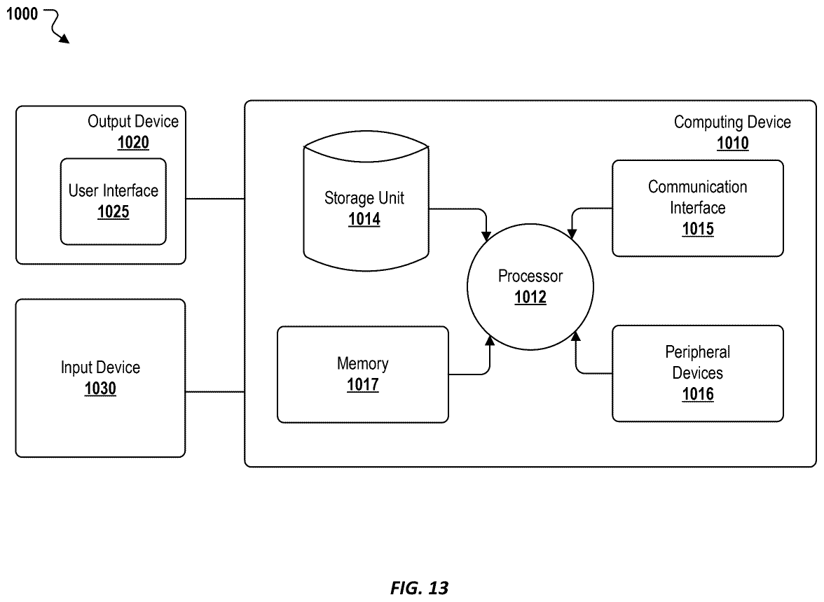

FIG. 13 depicts an example system 1000 that includes a computer or computing device 1010 that can be programmed or otherwise configured to implement systems or methods of the present disclosure. For example, the computing device 1010 can be programmed or otherwise configured to implement the methods described herein.

In the depicted embodiment, the computer or computing device 1010 includes an electronic processor (also “processor” and “computer processor” herein) 1012, which is optionally a single core, a multi core processor, or a plurality of processors for parallel processing. The depicted embodiment also includes memory 1017 (e.g., random-access memory, read-only memory, flash memory), electronic storage unit 1014 (e.g., hard disk or flash), communication interface 1015 (e.g., a network adapter or modem) for communicating with one or more other systems, and peripheral devices 1016, such as cache, other memory, data storage, microphones, speakers, etc. In some embodiments, the memory 1017, storage unit 1014, communication interface 1015 and peripheral devices 1016 are in communication with the electronic processor 1012 through a communication bus (shown as solid lines), such as a motherboard. In some embodiments, the bus of the computing device 1010 includes multiple buses. In some embodiments, the computing device 1010 includes more or fewer components than those illustrated in FIG. 13 and performs functions other than those described herein.

In some embodiments, the memory 1017 and storage unit 1014 include one or more physical apparatuses used to store data or programs on a temporary or permanent basis. In some embodiments, the memory 1017 is volatile memory and requires power to maintain stored information. In some embodiments, the storage unit 1014 is non-volatile memory and retains stored information when the computer is not powered. In further embodiments, memory 1017 or storage unit 1014 is a combination of devices such as those disclosed herein. In some embodiments, memory 1017 or storage unit 1014 is distributed across multiple machines such as a network-based memory or memory in multiple machines performing the operations of the computing device 1010.

In some cases, the storage unit 1014 is a data storage unit or data store for storing data. In some instances, the storage unit 1014 stores files, such as drivers, libraries, and saved programs. In some embodiments, the storage unit 1014 stores user data (e.g., user preferences and user programs). In some embodiments, the computing device 1010 includes one or more additional data storage units that are external, such as located on a remote server that is in communication through an intranet or the internet.

In some embodiments, methods as described herein are implemented by way of machine or computer executable code stored on an electronic storage location of the computing device 1010, such as, for example, on the memory 1017 or the storage unit 1014. In some embodiments, the electronic processor 1012 is configured to execute the code. In some embodiments, the machine executable or machine-readable code is provided in the form of software. In some examples, during use, the code is executed by the electronic processor 1012. In some cases, the code is retrieved from the storage unit 1014 and stored on the memory 1017 for ready access by the electronic processor 1012. In some situations, the storage unit 1014 is precluded, and machine-executable instructions are stored on the memory 1017.

Examples of operations performed by the electronic processor 1012 can include fetch, decode, execute, and write back. In some cases, the electronic processor 1012 is a component of a circuit, such as an integrated circuit. One or more other components of the computing device 1010 can be optionally included in the circuit. In some cases, the circuit is an application specific integrated circuit (ASIC) or a field programmable gate arrays (FPGAs). In some cases, the operations of the electronic processor 1012 can be distributed across multiple machines (where individual machines can have one or more processors) that can be coupled directly or across a network.

In some embodiments, the electronic processor 1012 may rely on a machine learning model to generate an output (e.g., quantitative value(s) or visual maps) related to snow cover. Machine learning algorithms can be employed to build a model to classify snow cover based on a dataset(s). Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets. For example, previously received snow maps or snow data may be employed to train various algorithms. Moreover, as described above, these algorithms can be continuously trained/retrained using real-time user data as it is received. In some embodiments, the machine learning algorithm employs regression modeling where relationships between variables are determined and weighted. In some embodiments, the machine learning algorithm employs regression modeling, where relationships between predictor variables and dependent variables are determined and weighted.

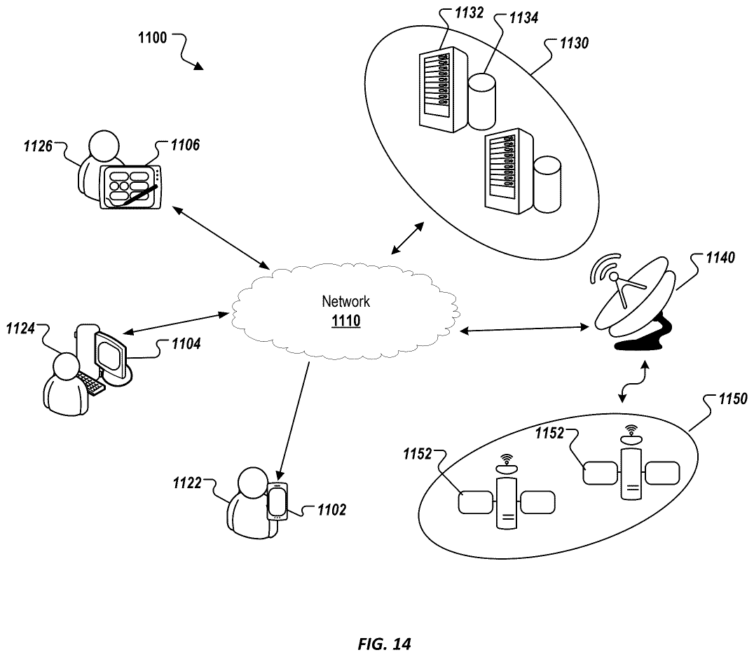

In some aspects, the computing device 1010 is optionally operatively coupled to a communication network, such as the network 1110 described with reference to FIG. 14, via the communication interface 1015. In some cases, the computing device 1010 communicates with one or more remote computer systems through the network. In some cases, a user can access the computing device 1010 via the network. In some cases, the computing device 1010 is configured as a node within a peer-to-peer network.

In some aspects, the computing device 1010 includes or is in communication with one or more output devices 1020. In some cases, the output device 1020 includes a display to send visual information to a user. In some cases, the output device 1020 is a liquid crystal display (LCD). In other cases, the output device 1020 is a thin film transistor liquid crystal display (TFT-LCD) or an organic light emitting diode (OLED) display. In some cases, the output device 1020 is a touch sensitive display that combines a display with a touch sensitive element that is operable to sense touch inputs as and functions as both the output device 1020 and the input device 1030. In still further cases, the output device 1020 is a combination of devices such as those disclosed herein. In some cases, the output device 1020 displays a user interface (UI) 1025 generated by the computing device (for example, software executed by the computing device 1010).

In some aspects, the computing device 1010 includes or is in communication with one or more input devices 1030 that are configured to receive information from a user. In some cases, the input device 1030 is a keyboard. In some cases, the input device 1030 is a keypad (e.g., a telephone-based keypad). In some cases, the input device 1030 is a cursor-control device including, by way of non-limiting examples, a mouse, trackball, track pad, joystick, game controller, or stylus. In some cases, as described above, the input device 1030 is a touchscreen or a multi-touchscreen. In other cases, the input device 1030 is a microphone to capture voice or other sound input. In other cases, the input device 1030 is a camera or video camera. In still further cases, the input device is a combination of devices such as those disclosed herein.

In some cases, the computing device 1010 includes an operating system configured to perform executable instructions. The operating system is, for example, software, including programs and data that manages the device's hardware and provides services for execution of applications.

It should also be noted that a plurality of hardware and software-based devices, as well as a plurality of different structural components may be used to implement the described examples. In addition, embodiments may include hardware, software, and electronic components or modules that, for purposes of discussion, may be illustrated and described as if most of the components were implemented solely in hardware. In some embodiments, the electronic based aspects of the disclosure may be implemented in software (e.g., stored on non-transitory computer-readable medium) executable by one or more processors, such as electronic processor 1012. As such, it should be noted that a plurality of hardware and software-based devices, as well as a plurality of different structural components may be employed to implement various embodiments. It should also be understood that although certain drawings illustrate hardware and software located within particular devices, these depictions are for illustrative purposes only. In some embodiments, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

FIG. 14 depicts an example environment 1100 that can be employed to execute embodiments of the present disclosure. The example system 1100 includes computing devices 1102, 1104, 1106; a back-end system 1130; a satellite transceiver 1140; a satellite constellation 1150, and a communication network 1110. The communication network (which may be an example of an “intervening internet protocol (IP) network”) 1110 may include wireless and wired portions. In some cases, the communication network 1110 is implemented using one or more existing networks, for example, a cellular network, the Internet, a land mobile radio (LMR) network, a Bluetooth™ network, a wireless local area network (for example, Wi-Fi), a wireless accessory Personal Area Network (PAN), a Machine-to-machine (M2M) network, and a public switched telephone network. The network may also include future developed networks. In some embodiments, the 1110 includes the Internet, an intranet, an extranet, or an intranet and/or extranet that is in communication with the Internet. In some embodiments, the network 1110 includes a telecommunication or a data network.

In some embodiments, the network 1110 connects web sites, devices (e.g., the computing devices 1102, 1104, and 1106), satellite transceiver 1140, and back-end systems (e.g., the back-end system 1130). In some embodiments, the network 1110 can be accessed over a wired or a wireless communications link. For example, mobile computing devices (e.g., the smartphone device 1102 and the tablet device 1106), can use a cellular network to access the network 1110.

In some examples, the users 1122, 1124, and 1126 interact with the system through a graphical user interface (GUI) or application that is installed and executing on their respective computing devices 1102, 1104, and 1106. In some examples, the computing devices 1102, 1104, and 1106 provide viewing data to screens with which the users 1122, 1124, and 1126, can interact. In some embodiments, the computing devices 1102, 1104, 1106 are sustainably similar to computing device 1010 depicted in FIG. 13. The computing devices 1102, 1104, and 1106 may each include any appropriate type of computing device, such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. Three user computing devices 1102, 1104, and 1106 are depicted in FIG. 14 for simplicity. In the depicted example environment 1100, the computing device 1102 is depicted as a smartphone, the computing device 1106 is depicted as a tablet-computing device, and the computing device 1104 is depicted a desktop computing device. It is contemplated, however, that embodiments of the present disclosure can be realized with any of the appropriate computing devices, such as those mentioned previously. Moreover, embodiments of the present disclosure can employ any number of devices as required.

In some embodiments, the back-end system 1130 includes at least one server device 1132 and at least one data store 1134. In some embodiments, the device 1132 is sustainably similar to computing device 1010 depicted in FIG. 13. In some embodiments, the back-end system 1130 may include server-class hardware type devices. In some embodiments, the server device 1132 is a server-class hardware type device. In some embodiments, the back-end system 1130 includes computer systems using clustered computers and components to act as a single pool of seamless resources when accessed through the network 1110. For example, such embodiments may be used in data center, cloud computing, storage area network (SAN), and network attached storage (NAS) applications. In some embodiments, the back-end system 1130 is deployed using a virtual machine(s). In some embodiments, the data store 1134 is a repository for persistently storing and managing collections of data. Example data store that may be employed within the described system include data repositories, such as a database as well as simpler store types, such as files, emails, and so forth. In some embodiments, the data store 1134 includes a database. In some embodiments, a database is a series of bytes or an organized collection of data that is managed by a database management system (DBMS). In some embodiments, the at least one server system 1132 hosts one or more computer-implemented services provided by the described system that users 1122, 1124, and 1126 can interact with using the respective computing devices 1102, 1104, and 1106.

In some embodiments, satellite constellation 1150 includes a group of satellites 1152 working together as a system. The satellites 1152 communicate with the radio transceiver 1140 (e.g., via a transponder). For example, the artificial satellites 1152 may be employed to collect a sequence of remote sensing data of snow cover, which are provided to the back-end system 1130 via the radio transceiver 1140 connected to the communications network 1110.

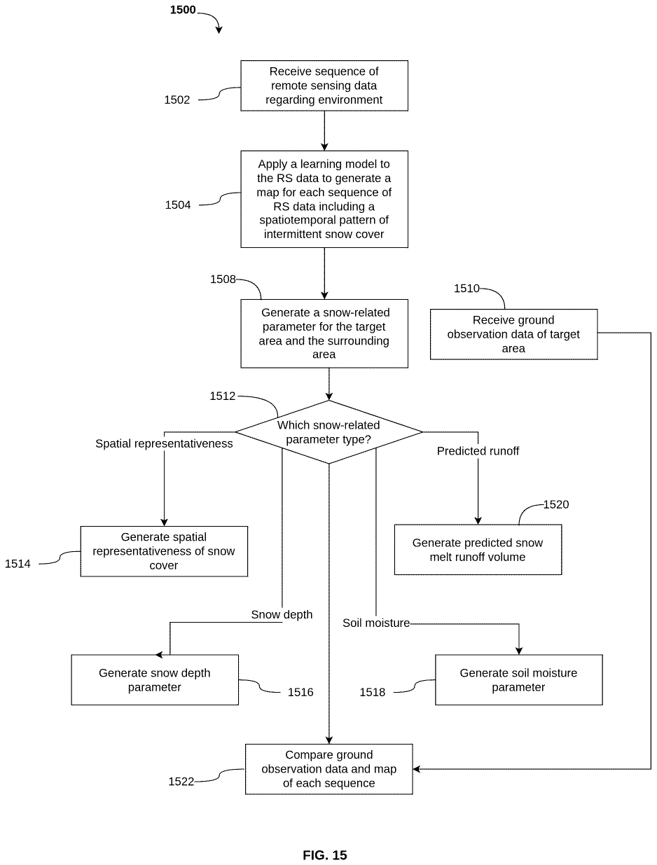

Referring to FIG. 15, a method 1500 for generating snow-related parameters from remote sensing data provides a structured approach for processing remote sensing data to derive various snow-related parameters that can be used for hydrological analysis and water resource management. The method 1500 begins with a step 1502, where a sequence of remote sensing (RS) data regarding an environment is received from a data source. The environment comprises a target area where changes have occurred and a surrounding area where different surface conditions have lead to contrasting response between the target area and the surrounding area.

The sequence of remote sensing data includes various types of data sources that capture snow cover information at different spatial and temporal resolutions. The RS data includes CubeSat imagery or lidar surveys that provide high-resolution observations of snow-covered areas. Additionally, the RS data includes data from an unmanned aerial vehicle, a drone, an airplane, or other satellites that can capture imagery across different spectral bands and at varying altitudes. CubeSat imagery provides near-daily coverage at 3-meter spatial resolution in Red, Green, Blue, and Near-Infrared bands, enabling frequent monitoring of snow cover dynamics. Lidar surveys generate high-precision snow depth measurements that serve as reference data for model training and validation.

The method 1500 includes filtering satellite scenes to select only those with less than 1% cloud cover for snow mapping analysis. This filtering process ensures that the selected imagery provides clear views of the ground surface without obstruction from cloud cover that would interfere with accurate snow detection. The filtering process utilizes cloud detection algorithms that analyze spectral characteristics of pixels to identify and exclude scenes with excessive cloud contamination.

The method 1500 uses Usable Data Mask products to classify pixels as Clear, Cloud, Haze, Cloud Shadow, or Snow for preprocessing. The Usable Data Mask (UDM) classification system processes each pixel in the remote sensing imagery and assigns it to one of these categories based on spectral analysis and machine learning algorithms. This pixel classification preprocessing step removes atmospheric interference and identifies areas suitable for snow cover analysis.

Following step 1502, the method 1500 proceeds to a step 1506, where a learning model is applied to the RS data to generate a map for each sequence of RS data including a spatiotemporal pattern of intermittent snow cover. The learning model employs a transfer learning approach with a pretrained convolutional neural network-based approach for image segmentation tasks. The learning model utilizes a U-Net network with a ResNet-50 encoder pre-trained on ImageNet to extract relevant features from the remote sensing imagery efficiently using knowledge gained through transfer learning.

The U-Net architecture includes skip connections between encoder and decoder parts of the network that enable learning from both high-level coarser features and low-level finer features in the imagery. The ResNet-50 encoder serves as the feature extraction component that processes the input imagery and identifies patterns relevant to snow detection. The encoder portion remains frozen during training, with learning limited to the U-Net decoder layers that reconstruct the spatial snow cover maps from the extracted features.

The learning model processes the RS data in 512×512-pixel segments of RGB imagery along with corresponding binary snow masks for training. These segments provide manageable input sizes that balance computational efficiency with spatial context preservation. The 512×512 pixel dimensions capture sufficient local spatial patterns while maintaining processing speed during model training and inference operations.

The method 1500 applies a 10 cm threshold to convert snow depth maps into binary snow cover labels for model training. This threshold conversion accounts for vertical uncertainties in lidar snow depth measurements and provides consistent binary classification targets. Snow depth values exceeding the 10 cm threshold receive classification as snow-covered pixels, while values below the threshold receive classification as snow-free pixels. The binary snow cover labels serve as ground truth references during the supervised learning process.

The learning model training process utilizes Binary Cross Entropy Loss as the loss function to optimize the model parameters. Binary Cross Entropy Loss measures the difference between predicted snow cover probabilities and actual binary snow cover labels, providing gradient information for parameter updates. The loss function guides the learning process toward accurate pixel-wise snow cover classification across the training dataset.

The training process employs an Adam optimizer with specific learning rate parameters to control the parameter update process. The Adam optimizer uses a learning rate of 10 \hat{ }-3 for the first 100 epochs of training, providing relatively aggressive parameter updates during initial learning phases. The learning rate decreases to 10\hat{ }-4 for the final 100 epochs, enabling fine-tuning of model parameters with smaller, more precise updates. This learning rate schedule balances rapid initial convergence with stable final optimization.

The spatiotemporal pattern of intermittent snow cover generated by the learning model captures snow cover dynamics across both spatial and temporal dimensions. The spatial component represents the geographic distribution of snow cover within each processed scene, while the temporal component tracks changes in snow cover patterns across the sequence of remote sensing observations. The intermittent snow cover patterns reflect the ephemeral nature of snowpack in regions where snow accumulates and melts repeatedly throughout winter seasons, creating complex spatiotemporal signatures that distinguish these areas from regions with persistent seasonal snow cover.

Following step 1506, the method 1500 proceeds to a step 1508, where a snow-related parameter for the target area and the surrounding area is generated based on the RS data. The snow-related parameter represents derived information about snow conditions that extends beyond simple binary snow cover classification. The generation process combines information from multiple sequences of remote sensing data and the spatiotemporal patterns derived from the learning model to produce quantitative measures of snow dynamics and characteristics.

The method 1500 calculates snow persistence as the ratio of snow-covered days to the number of clear-sky days during winter seasons. Snow persistence provides a normalized measure of snow cover duration that accounts for data availability limitations caused by cloud cover and other atmospheric conditions. The calculation involves counting the number of days with detected snow cover at each pixel location and dividing by the total number of clear-sky observation days during the winter season from November 1st to April 30th.

The snow persistence calculation enables characterization of snow regime transitions from no snow conditions through ephemeral snow dynamics to transitional snow patterns. Snow persistence values below 0.05 indicate no snow regimes, values between 0.05 and 0.20 represent ephemeral snow conditions, and values exceeding 0.20 characterize transitional snow dynamics. These thresholds provide quantitative boundaries for classifying different snow regime types based on temporal persistence patterns.

At a step 1510, the method 1500 determines which snow-related parameter type is to be processed. This determination step directs the processing workflow toward specific parameter generation pathways based on the intended application or analysis requirements. The parameter type selection influences subsequent processing steps and determines the specific algorithms and data combinations used for parameter derivation.

The snow-related parameters generated from the RS data and spatiotemporal patterns include spatial representativeness, snow depth, soil moisture, and predicted runoff. Spatial representativeness parameters quantify how well point-scale measurements would represent snow conditions across surrounding landscape areas. Snow depth parameters provide volumetric measurements of snow accumulation derived from the relationship between snow cover persistence and topographic characteristics. Soil moisture parameters utilize the connection between snow disappearance timing and peak soil moisture conditions to estimate subsurface water availability. Predicted runoff parameters estimate snowmelt contribution to streamflow based on snow cover duration and spatial distribution patterns.

The computing device assesses spatial representativeness by analyzing snow-covered days at specific locations relative to spatially averaged values across defined areas. The assessment process involves extracting snow cover predictions from the generated maps at 1000-meter×1000-meter areas centered on locations of interest. These areas encompass 333×333 pixels at 3-meter resolution, providing comprehensive spatial sampling around each location.

In some embodiments, ground observation data of the target area may be received at any point when available. The ground observation data includes Snowtography, SNOTEL, or other in-site sensors that provide direct measurements of snow conditions at specific locations. Snowtography systems use trail cameras to capture images of snow depth stakes, providing visual documentation of snow accumulation and melting patterns. SNOTEL stations measure snow water equivalent, snow depth, and related meteorological parameters through automated instrumentation. Other in-site sensors include weather stations, temperature loggers, and precipitation gauges that collect complementary environmental data.

When ground observation data is available, it may be compared with the generated snow-related parameters to evaluate spatial representativeness of the generated parameters. This comparison process establishes correspondence between point-scale ground measurements and the spatially distributed snow-related parameters generated from the learning model. The comparison involves extracting parameter values from the generated maps at locations corresponding to ground observation sites and evaluating the agreement between predicted and observed snow conditions. The comparison process utilizes a 3×3-pixel neighborhood centered on each ground observation site to represent snow cover from the model predictions. This neighborhood approach accounts for potential spatial misalignment between ground measurement locations and satellite pixel coordinates while providing representative values for comparison. The neighborhood averaging reduces the impact of individual pixel noise and provides more robust comparison metrics between ground observations and remote sensing predictions. The comparison generates accuracy metrics including Precision, Recall, F1 Score, and Intersection over Union to quantify model performance. These metrics evaluate the agreement between predicted snow cover maps and ground truth observations across different snow conditions and temporal periods.

If the parameter type is spatial representativeness, the method 1500 proceeds to a step 1512, where a spatial representativeness of snow cover is generated. The step 1512 addresses the challenge of determining how well point-scale measurements would represent snow conditions across the broader landscape surrounding measurement locations. This spatial representativeness assessment provides information about the degree to which individual locations capture the snow cover variability present in their surrounding areas.

The parameter generation process leverages the high spatial resolution of the snow cover maps to capture sub-grid variability that influences hydrological processes. The 3-meter resolution enables detection of snow cover heterogeneity caused by topographic features, vegetation structure, and microclimatic conditions that affect snow accumulation and melting patterns. This detailed spatial information supports more accurate parameter estimation compared to coarser resolution products that average out local-scale variations.

The spatial representativeness assessment calculates differences between point-scale snow-covered days and spatial average values across the surrounding landscape. These differences quantify the degree to which individual locations deviate from the broader spatial patterns in their vicinity. Positive differences indicate that specific locations experience longer snow cover duration than their surrounding areas, while negative differences suggest shorter snow cover duration at those locations compared to nearby terrain.

The assessment process accounts for topographic and vegetation influences on spatial representativeness by analyzing correlations between snow cover patterns and physical landscape attributes. The analysis examines relationships between snow-covered days and elevation, northness index, and canopy height model values across areas of interest. These correlations reveal how terrain aspect, slope orientation, and forest structure contribute to spatial variability in snow cover duration.

The computing device generates snow persistence maps based on the spatiotemporal pattern of intermittent snow cover to evaluate the representativeness of specific locations relative to the broader spatial variability in the watershed. The snow persistence maps represent the ratio of snow-covered days to clear-sky observation days during winter seasons, scaled to annual basis by assuming no snow cover during non-winter periods. These maps provide spatially continuous representations of snow cover duration patterns across the target area.

The assessment identifies elevation-dependent transitions in the factors controlling spatial representativeness of snow cover. At low to mid-elevation locations below 2200 meters, northness index serves as the dominant control on spatial snow cover patterns, with correlation coefficients exceeding 0.65. At higher elevation locations above 2200 meters, canopy height model correlations increase while northness index influence decreases, indicating a transition from terrain-dominated to vegetation-dominated controls on snow cover spatial patterns.

When ground observation data is available for comparison, the spatial representativeness assessment reveals that differences between point measurements and spatial averages range from −2.4 to +6.8 days across different observation sites. These variations reflect the influence of local terrain characteristics on snow accumulation and retention patterns. Sites positioned on flat terrain demonstrate larger discrepancies compared to surrounding areas that include diverse slope orientations, while sites in areas with balanced north-facing and south-facing slopes show smaller differences due to averaging effects across contrasting terrain aspects.

The snow persistence maps enable quantification of sub-grid variability within coarser resolution pixels through calculation of coefficient of variation values. The coefficient of variation represents the standard deviation of snow persistence divided by mean snow persistence within each spatial unit, providing a normalized measure of spatial heterogeneity. Higher coefficient of variation values indicate greater spatial variability in snow cover patterns, while lower values suggest more uniform snow conditions across the area.

The spatial representativeness analysis demonstrates that specific locations exhibit varying degrees of representativeness depending on their position within the landscape and the spatial scale of analysis. The high-resolution snow cover maps enable detection of fine-scale spatial heterogeneity that influences the relationship between point locations and surrounding area conditions. This detailed spatial information supports improved understanding of how individual locations relate to broader watershed-scale snow cover patterns and processes.

If the parameter type is snow depth, the method 1500 moves to a step 1514, where a snow depth parameter is generated. In some embodiments, the snow depth parameter generation process incorporates results from the spatial representativeness assessment to enhance the accuracy of volumetric measurements. The step 1514 provides volumetric measurements that quantify the three-dimensional characteristics of snow accumulation across the target area. The snow depth parameter generation process combines the spatiotemporal snow cover patterns with topographic and environmental data to derive quantitative estimates of snow volume distribution.

The spatial representativeness analysis demonstrates that ground observation sites exhibit varying degrees of representativeness depending on their position within the landscape and the spatial scale of analysis. The high-resolution snow cover maps enable detection of fine-scale spatial heterogeneity that influences the relationship between point measurements and surrounding area conditions. This detailed spatial information supports improved understanding of how individual ground observation sites relate to broader watershed-scale snow cover patterns and processes.

If the parameter type is snow depth, the method 1500 moves to a step 1516, where a snow depth parameter is generated. In some embodiments, the snow depth parameter generation process incorporates results from the spatial representativeness assessment to enhance the accuracy of volumetric measurements. The step 1516 provides volumetric measurements that quantify the three-dimensional characteristics of snow accumulation across the target area. The snow depth parameter generation process combines the spatiotemporal snow cover patterns with topographic and environmental data to derive quantitative estimates of snow volume distribution.

The snow depth parameter generation utilizes snow line derivation as a fundamental component for characterizing snow accumulation patterns across elevation gradients. The method 1500 derives snow line elevation as the lowest elevation bin with an average snow cover fraction exceeding 50%. This snow line derivation process involves analyzing snow cover maps across 50-meter elevation bins and identifying the minimum elevation where snow cover fraction reaches the 50% threshold. The snow line elevation serves as an indicator of the rain-to-snow transition zone and provides information about the altitudinal limits of snow accumulation during specific time periods.

The snow line derivation process tracks temporal variations in the elevation boundary between snow-covered and snow-free areas throughout winter seasons. The derived snow line elevations exhibit significant interannual variability, with distributions that peak around 2200 meters elevation, confirming transitions in snow regime characteristics at this elevation threshold. During wet years, the snow line distribution exhibits multiple peaks at different elevations due to frequent snow events that reset the snow line position and prevent retreat to higher elevations until late in the season.

The method 1500 employs coefficient of variation analysis for quantifying sub-grid variability within MODIS pixels along elevation gradients, building upon the spatial representativeness assessment framework established in step 1512. The coefficient of variation analysis calculates the ratio of standard deviation to mean snow persistence values within each spatial unit, providing normalized measures of spatial heterogeneity in snow cover patterns. This analysis reveals that coefficient of variation decreases with elevation from approximately 0.6 at low elevations to less than 0.1 at high elevations, reflecting combined changes in mean snow persistence and spatial variability.

The coefficient of variation analysis demonstrates that capturing sub-grid variability in snow cover becomes more important for intermittent snowpacks at low to mid elevations with lower snow persistence values. Higher elevation zones exhibit higher snow persistence and lower spatial variations among pixels, while lower elevation zones display the opposite pattern with greater spatial heterogeneity. The analysis quantifies the spatial variability not captured by coarser resolution products but retrieved through the deep learning model applied to high-resolution imagery.

The snow depth parameter generation incorporates northness index calculation as cos (aspect)× sin (slope) to characterize topographic effects on snow distribution patterns. The northness index calculation provides quantitative measures of terrain orientation that influence snow accumulation and retention processes. North-facing slopes receive positive northness index values, while south-facing slopes receive negative values, enabling systematic analysis of aspect-related snow cover variations across the landscape.

The northness index calculation reveals elevation-dependent transitions in topographic controls on snow distribution. At low to mid-elevation sites below 2200 meters, northness index serves as the dominant control on snow cover patterns with correlation coefficients exceeding 0.65. The northness index influence decreases at higher elevations where other factors such as forest structure become more important for determining snow cover spatial patterns.

The method 1500 integrates canopy height model data to analyze forest structure effects on snow cover dynamics at high elevations. The canopy height integration process utilizes 1-meter resolution canopy height model data generated from satellite imagery to characterize vegetation structure across the target area. This integration enables analysis of how forest canopy characteristics influence snow accumulation, retention, and ablation processes through mechanisms such as canopy interception, sublimation, and radiation modification.

The canopy height integration reveals that forest structure effects become more pronounced at higher elevation sites where correlation between snow-covered days and canopy height model values increases substantially. The negative correlation between snow-covered days and canopy height reflects the impact of forest canopies in reducing snow cover through processes such as canopy sublimation and altered energy balance conditions. The canopy height integration provides detailed spatial information about vegetation effects that complement topographic controls on snow distribution patterns.

The snow depth parameter generation utilizes wet-bulb temperature derived from PRISM data to characterize rain-to-snow transition zones across the target area. The wet-bulb temperature data provides information about atmospheric conditions that determine whether precipitation falls as rain or snow at different elevations and locations. The PRISM data derives wet-bulb temperature from monthly mean air temperature and dew point temperature measurements at 800-meter resolution using established approximation methods.

The wet-bulb temperature analysis reveals elevation gradients that range from +6 to −2 degrees Celsius during winter seasons, indicating transitions from rain-dominated to snow-dominated precipitation regimes from lower to higher elevations. The wet-bulb temperature threshold of 0 degrees Celsius corresponds closely with elevation zones where mean snow persistence increases rapidly, confirming the relationship between atmospheric temperature conditions and snow accumulation patterns.

The volumetric measurements generated through the snow depth parameter process provide quantitative estimates of snow volume distribution that extend beyond simple binary snow cover classification. These measurements combine snow cover persistence patterns with topographic, vegetation, and climatic data to estimate three-dimensional snow accumulation characteristics across the target area. The volumetric measurements support hydrological analysis applications that require quantitative information about snow water storage and potential melt contributions to streamflow.

The snow depth parameter generation process demonstrates strong correlations between snow persistence values derived from the high-resolution snow cover maps and topographic characteristics. When ground-based snow depth measurements from observation stations are available for comparison, the correlation coefficients exceed 0.83 for relationships between seasonal average snow persistence and average snow depth across observation sites, validating the use of snow persistence as a proxy for snow accumulation in regions where direct snow depth retrieval remains challenging.

The integration of multiple data sources and analytical approaches in the snow depth parameter generation enables comprehensive characterization of snow accumulation patterns across complex terrain. The combination of snow line derivation, coefficient of variation analysis, northness index calculation, canopy height integration, and wet-bulb temperature analysis provides detailed information about the physical processes controlling snow distribution and accumulation in intermittent snowpack regions.

If the parameter type is soil moisture, the method 1500 proceeds to a step 1516, where a soil moisture parameter is generated. In some embodiments, the soil moisture parameter generation process leverages insights from both the spatial representativeness assessment and the volumetric data produced during snow depth generation to enhance estimation accuracy. The step 1516 addresses the hydrological connection between snow cover dynamics and subsurface water availability through analysis of snow disappearance timing and its relationship to soil moisture conditions. The soil moisture parameter generation process leverages the established relationship between snowmelt timing and peak soil moisture occurrence to estimate subsurface water storage and availability across the target area.

The soil moisture parameter generation incorporates snow disappearance date correlation with peak soil moisture timing to establish hydrologic relationships between snow cover dynamics and subsurface water conditions. The correlation process analyzes the temporal relationship between snow disappearance dates derived from the high-resolution snow cover maps and peak soil moisture timing observed at ground-based monitoring stations. This correlation establishes quantitative relationships that enable inference of soil moisture conditions based on snow cover persistence and disappearance patterns across the broader landscape.

The snow disappearance date correlation process demonstrates that snow disappearance dates estimated from the high-resolution imagery closely align with peak soil moisture timing, with mean bias of 0 days relative to ground-based observations compared to −16 day bias from coarser resolution products. This improved accuracy in snow disappearance date estimation leads to more precise estimates of soil moisture drawdown periods and subsurface water availability timing. The correlation analysis reveals that snow disappearance dates serve as reliable predictors of when soil moisture reaches maximum values following snowmelt infiltration.

The method 1500 utilizes winter season aggregation where time series data is aggregated through entire winter seasons to generate snow persistence products representing days covered by snow. The winter season aggregation process combines daily snow cover observations from November 1st through April 30th to calculate cumulative snow-covered days and snow persistence values for each pixel location. This aggregation approach accounts for the intermittent nature of snow cover in the target region, where snow accumulates and melts repeatedly throughout winter seasons rather than persisting continuously.

The winter season aggregation process generates snow persistence products by calculating the ratio of snow-covered days to clear-sky observation days during each winter season. The aggregation accounts for data availability limitations caused by cloud cover and atmospheric conditions that prevent reliable snow cover detection on certain days. The resulting snow persistence values provide normalized measures of snow cover duration that enable comparison across different years and locations with varying observation frequencies.

The soil moisture parameter generation process demonstrates that seasonal average snow persistence correlates robustly with average snow depth across observation sites, with correlation coefficients of 0.83 compared to 0.65 for coarser resolution estimates. This strong correlation validates snow persistence as a proxy for snow accumulation and subsequent soil moisture input through snowmelt processes. In some cases, the volumetric measurements generated during the snow depth parameter process may be utilized to further refine soil moisture estimates by providing three-dimensional snow accumulation data. The correlation analysis confirms that areas with higher snow persistence values experience greater snow water input and correspondingly higher soil moisture levels during snowmelt periods.

The soil moisture inference process utilizes the connection between snow disappearance timing and peak soil moisture conditions to estimate subsurface water availability based on snow cover patterns. The inference process recognizes that snow disappearance dates indicate when snowmelt water becomes available for soil infiltration and groundwater recharge. Areas with later snow disappearance dates receive snowmelt input later in the season, affecting the timing and magnitude of soil moisture peaks and subsequent drawdown patterns.

The soil moisture parameter generation reveals that snow persistence values correlate more strongly with second-layer soil moisture dynamics compared to surface-layer soil moisture conditions. The correlation coefficients reach 0.28 for second-layer soil moisture while remaining very weak at 0.01 for surface-layer conditions. This difference reflects rapid percolation of snowmelt water to deeper soil layers and the influence of rainfall events on surface soil moisture that obscure the snow-related signal at shallow depths.

The method 1500 accounts for initial soil conditions in the soil moisture inference process by analyzing antecedent moisture states and soil characteristics that influence snowmelt infiltration and retention. The initial soil conditions include soil moisture content prior to snowmelt events, soil texture and structure properties that affect infiltration rates, and frozen soil conditions that may limit water penetration during early snowmelt periods. These initial conditions modify the relationship between snow cover patterns and resulting soil moisture distributions.

The soil moisture inference process incorporates elevation-dependent variations in snowmelt timing and soil moisture response patterns. Higher elevation areas experience later snowmelt and correspondingly delayed soil moisture peaks, while lower elevation areas receive earlier snowmelt input and earlier soil moisture maxima. The elevation gradient creates spatial patterns in soil moisture timing that correspond to the elevation-dependent snow cover persistence patterns captured in the high-resolution snow maps.

The soil moisture parameter generation process utilizes the detailed spatial resolution of the snow cover maps to capture fine-scale variations in snowmelt input that influence local soil moisture patterns. The 3-meter resolution enables detection of snow cover heterogeneity caused by topographic features, vegetation structure, and microclimatic conditions that create spatial variability in snowmelt timing and magnitude. This detailed spatial information supports more accurate soil moisture parameter estimation compared to coarser resolution approaches that average out local-scale variations in snow-soil interactions.

The correlation analysis between snow persistence and soil moisture demonstrates the utility of high-resolution snow cover observations for understanding hydrological processes in intermittent snowpack regions. The strong correlations between snow-related parameters and soil moisture conditions validate the use of snow cover persistence as an indicator of subsurface water availability and timing. In some embodiments, the integration of spatial representativeness assessments with volumetric snow depth measurements provides enhanced capabilities for soil moisture parameter estimation. The soil moisture parameters generated through this process provide valuable information for water resource management, agricultural planning, and ecosystem monitoring applications that depend on understanding soil water availability patterns.

If the parameter type is predicted runoff, the method 1500 moves to a step 1520, where a predicted snow melt runoff volume is generated. The step 1520 addresses water resource forecasting applications by combining the volumetric snow measurements and soil moisture conditions derived from the spatial representativeness analysis to estimate the quantity of water that will become available through snowmelt processes. The predicted snow melt runoff volume generation provides water managers with quantitative forecasts of available water resources based on the detailed snow cover analysis conducted through the preceding steps.

The computing device generates a predicted snow melt runoff volume for the target area based on the snow-related parameter through integration of multiple hydrological components derived from the high-resolution snow cover analysis. The runoff prediction process combines the volumetric snow measurements that quantify three-dimensional snow accumulation characteristics with the soil moisture parameters that indicate subsurface water storage capacity and infiltration potential. This integration enables comprehensive assessment of how accumulated snow will contribute to surface water availability when melting occurs.

The runoff prediction derivation utilizes the volumetric snow measurements obtained through the snow depth parameter generation process to estimate the total water equivalent stored in the snowpack across the target area. The volumetric measurements provide spatial distributions of snow accumulation that account for topographic effects, vegetation influences, and elevation-dependent snow persistence patterns. These measurements serve as the primary input for calculating potential water yield from snowmelt processes across different portions of the watershed.

The predicted snow melt runoff volume calculation incorporates the soil moisture conditions derived from the snow disappearance timing analysis to account for infiltration losses and subsurface water storage effects. The soil moisture parameters indicate the capacity of soils to absorb snowmelt water before generating surface runoff, with areas having lower antecedent soil moisture exhibiting greater infiltration potential and reduced runoff generation. The integration of soil moisture conditions enables more accurate runoff predictions by accounting for the portion of snowmelt that will be retained in subsurface storage rather than contributing to streamflow.

The runoff volume prediction process utilizes the spatial representativeness analysis to scale point-scale relationships between snow cover persistence and runoff generation across the broader landscape. The spatial representativeness assessment provides information about how local snow accumulation and melting patterns relate to watershed-scale hydrological processes. This scaling approach enables extrapolation of runoff relationships derived from ground observation sites to areas without direct measurements, improving the spatial coverage and accuracy of runoff predictions.

The computing device employs elevation-dependent snowmelt timing relationships derived from the snow line analysis to predict the temporal distribution of runoff generation throughout the melting season. The elevation gradients in snow persistence and disappearance timing create predictable patterns in when different portions of the watershed will contribute snowmelt to streamflow. Higher elevation areas with longer snow persistence contribute runoff later in the season, while lower elevation areas with shorter snow persistence generate earlier runoff contributions.

The predicted runoff volume calculation accounts for the coefficient of variation in snow persistence across different elevation zones to estimate the spatial heterogeneity in runoff generation potential. Areas with higher coefficient of variation values exhibit greater spatial variability in snow accumulation and melting patterns, leading to more distributed runoff generation across time and space. Areas with lower coefficient of variation values produce more synchronized runoff generation due to more uniform snow conditions across the landscape.

The runoff prediction process incorporates the northness index effects on snow accumulation and melting to account for aspect-related variations in runoff timing and magnitude. North-facing slopes with higher northness index values retain snow longer and generate runoff later in the season compared to south-facing slopes with lower northness index values. This aspect-related variability creates spatial patterns in runoff generation that influence the overall watershed response to snowmelt processes.

The computing device utilizes canopy height model data to account for forest structure effects on snowmelt rates and runoff generation patterns. Forest canopies modify snowmelt processes through shading effects that reduce solar radiation input and wind protection that alters turbulent heat exchange. Areas with taller canopy heights experience slower snowmelt rates and more gradual runoff generation compared to open areas with lower canopy heights that experience more rapid melting under direct solar radiation.

The predicted snow melt runoff volume generation incorporates wet-bulb temperature relationships to account for rain-on-snow events that can accelerate melting and increase runoff generation beyond levels predicted from temperature-driven melting alone. Rain-on-snow events occur when warm, moist air masses bring precipitation to areas with existing snow cover, adding both liquid water input and additional energy for melting processes. The wet-bulb temperature analysis identifies elevation zones and time periods when rain-on-snow events are most likely to occur and contribute to enhanced runoff generation.

The runoff volume prediction process utilizes the winter season aggregation approach to estimate cumulative snowmelt contributions across entire melting seasons rather than individual storm events. The seasonal aggregation accounts for the intermittent nature of snow accumulation and melting in the target region, where multiple accumulation and partial melting cycles occur throughout winter before final snowpack disappearance. This approach provides seasonal water yield estimates that are more relevant for water resource planning applications than event-based predictions.

The computing device generates runoff forecasts by combining the spatial snow persistence patterns with historical relationships between snow cover duration and streamflow generation observed at gauging stations within the watershed. These relationships establish quantitative connections between the snow-related parameters derived from the high-resolution analysis and actual water yield measurements. The historical relationships enable calibration of the runoff prediction algorithms and provide confidence bounds for the forecasted water availability estimates.

The predicted runoff volume calculation accounts for sub-grid variability in snow cover patterns that influences the timing and magnitude of runoff generation at scales finer than traditional hydrological modeling approaches. The 3-meter resolution snow cover analysis captures fine-scale heterogeneity in snow distribution that creates spatial variability in melting rates and runoff contributions. This detailed spatial information enables more accurate runoff predictions by accounting for the distributed nature of snowmelt processes across complex terrain.

The runoff prediction process provides water managers with forecasts of available water resources that include both total seasonal water yield estimates and temporal distribution patterns of runoff generation throughout the melting season. The forecasts indicate when peak runoff periods are likely to occur based on elevation-dependent melting patterns and how total water availability compares to historical averages based on snow persistence analysis. These forecasts support water resource management decisions including reservoir operations, irrigation scheduling, and flood risk assessment.

The predicted snow melt runoff volume generation demonstrates the practical application of the detailed snow cover analysis for water resource management in regions with intermittent snowpack conditions. The integration of volumetric snow measurements, soil moisture conditions, and spatial representativeness analysis provides comprehensive information about snowmelt contributions to water availability. The runoff predictions enable proactive water management strategies that account for the spatial and temporal complexity of snowmelt processes in complex terrain environments.

At a step 1522, when ground observation data is available, the method 1500 compares the ground observation data with the generated snow-related parameters to evaluate the accuracy and spatial representativeness of the parameters derived from RS data. This comparison step is optional and occurs only when ground observation data has been received. The comparison process establishes correspondence between point-scale ground measurements and the spatially distributed snow-related parameters generated from the learning model and RS data. The comparison involves extracting parameter values from the generated maps at locations corresponding to ground observation sites and evaluating the agreement between predicted and observed snow conditions across different snow regimes and temporal periods.

The comparison process at step 1522 generates accuracy metrics including Precision, Recall, F1 Score, and Intersection over Union to quantify the performance of the snow-related parameters. These metrics evaluate the agreement between the RS-derived parameters and ground truth observations, providing validation of the model predictions across different snow conditions, elevation zones, and temporal periods. The comparison process calculates true positive, true negative, false positive, and false negative classifications by comparing the generated snow-related parameters with ground-based measurements at co-located areas.

The comparison at step 1522 utilizes a 3×3-pixel neighborhood centered on each ground observation site to represent the snow-related parameters from the generated maps. This neighborhood approach accounts for potential spatial misalignment between ground measurement locations and satellite pixel coordinates while providing representative parameter values for comparison. The neighborhood averaging reduces the impact of individual pixel noise and provides more robust comparison metrics between ground observations and the RS-derived parameters. The validation results from this comparison step inform the reliability and accuracy of the snow-related parameters for hydrological analysis and water resource management applications.

The system and method generate maps that include the spatiotemporal pattern at near-daily, 3-meter resolution, providing unprecedented detail for monitoring intermittent snow cover dynamics. The 3-meter spatial resolution captures fine-scale snow cover heterogeneity that results from local terrain features, vegetation structure, and microclimatic conditions that operate at scales much smaller than conventional remote sensing products. This high spatial resolution enables detection of snow cover variations caused by individual trees, small topographic features, and localized slope orientation effects that influence snow accumulation and retention patterns.

The near-daily temporal resolution component of the spatiotemporal pattern enables tracking of rapid changes in snow cover that characterize intermittent snowpack regions. Intermittent snowpacks undergo frequent accumulation and melting cycles throughout winter seasons, with snow cover appearing and disappearing on timescales of days to weeks rather than persisting continuously. The near-daily observation frequency captures these dynamic processes that would be missed by less frequent observation schedules, providing complete documentation of snow cover evolution throughout winter periods.

The combination of 3-meter spatial resolution and near-daily temporal frequency creates a spatiotemporal data structure that resolves both fine-scale spatial patterns and rapid temporal changes simultaneously. This spatiotemporal resolution enables analysis of how local terrain and vegetation features influence the timing and duration of snow cover at individual pixel locations. The detailed resolution reveals that snow cover persistence varies dramatically across short distances due to aspect effects, canopy shading, and elevation microgradients that create complex spatial mosaics of snow-covered and snow-free areas.

The high spatial resolution component enables capture of detailed sub-grid variability in snow cover at scales relevant to local terrain and vegetation influences that control snowpack dynamics. Traditional coarse-resolution products average snow conditions across large areas, obscuring the fine-scale heterogeneity that drives hydrological processes in complex terrain. The 3-meter resolution preserves spatial detail that reveals how individual landscape features create snow cover patterns, enabling analysis of process-level controls on snow distribution and persistence.

The sub-grid variability captured at 3-meter resolution demonstrates significant spatial heterogeneity within areas corresponding to single pixels of coarser resolution products. Coefficient of variation analysis reveals that spatial variability in snow persistence within 1-kilometer areas ranges from less than 0.1 at high elevations to greater than 0.6 at low elevations. This sub-grid variability information provides quantitative measures of spatial heterogeneity that cannot be detected using coarser resolution approaches but influences hydrological processes including soil moisture recharge, runoff generation, and groundwater infiltration.

The terrain influences captured at 3-meter resolution include slope orientation effects that create systematic differences in snow cover duration between north-facing and south-facing areas within short distances. The high resolution enables detection of aspect-related snow cover variations that occur across individual hillslopes and small drainage basins. These terrain influences operate at spatial scales of tens to hundreds of meters, requiring the fine spatial resolution to resolve the resulting snow cover patterns accurately.

The vegetation influences captured at 3-meter resolution include forest canopy effects on snow accumulation, retention, and melting processes that vary at the scale of individual trees and forest gaps. The high resolution enables analysis of how canopy structure creates spatial patterns in snow cover through processes including canopy interception, sublimation, and radiation modification. Forest edges, canopy gaps, and variations in tree density create fine-scale patterns in snow cover that influence local hydrological processes and require high spatial resolution to characterize accurately.

Referring to FIG. 15, the method generates maps with spatiotemporal patterns that combine the high spatial resolution with frequent temporal sampling to create comprehensive documentation of snow cover dynamics. The spatiotemporal pattern generation process produces time series of detailed snow cover maps that track changes in fine-scale spatial patterns throughout winter seasons. This approach enables analysis of how local terrain and vegetation controls on snow cover vary temporally as meteorological conditions change throughout winter periods.

The near-daily temporal resolution allows tracking of rapid changes in intermittent snowpack dynamics throughout winter seasons, capturing the ephemeral nature of snow cover in regions where snowpacks accumulate and disappear repeatedly. Intermittent snowpack regions experience frequent transitions between snow-covered and snow-free conditions driven by temperature fluctuations, precipitation variability, and solar radiation changes. The near-daily observation frequency documents these transitions with sufficient temporal detail to analyze the processes controlling snow cover persistence and disappearance.

The rapid changes tracked through near-daily observations include snow accumulation events that can cover large areas within single days, followed by melting processes that remove snow cover over periods of days to weeks. The temporal resolution captures the complete evolution of these accumulation and ablation cycles, providing information about the duration and intensity of snow cover episodes. This temporal detail enables analysis of how meteorological forcing translates into snow cover responses across different terrain and vegetation conditions.

The intermittent snowpack dynamics captured through near-daily observations reveal complex temporal patterns that distinguish these regions from areas with persistent seasonal snow cover. Intermittent snowpacks exhibit multiple accumulation and partial melting cycles throughout winter seasons, creating temporal signatures that reflect the marginal climatic conditions in these regions. The near-daily resolution documents these complex temporal patterns that provide insights into the sensitivity of snow cover to climate variability and change.

The spatiotemporal pattern at near-daily, 3-meter resolution enables comprehensive characterization of snow cover variability across multiple scales simultaneously. The high spatial resolution captures local-scale heterogeneity while the frequent temporal sampling documents rapid changes, creating a data structure that supports analysis of snow cover processes from individual pixels to watershed scales. This multi-scale capability provides information needed for applications ranging from local hydrological process understanding to regional water resource management.

The detailed spatiotemporal resolution supports improved understanding of the physical processes controlling snow cover in complex terrain environments. The combination of fine spatial and temporal resolution enables analysis of how topographic, vegetation, and climatic factors interact to create the observed patterns of snow cover persistence and variability. This process-level understanding supports development of improved snow cover prediction capabilities and enhanced water resource management strategies in regions with intermittent snowpack conditions.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM

(Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. The term “approximately” as used herein refers to any values, including both integers and fractional components that are within a variation of up to +10% of the value modified by the term “about.” In certain aspects, the term “approximately” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “approximately” can mean within 3 or more than 3 standard deviations, per the practice in the art. Alternatively, such as with respect to biological systems or processes, the term “about” can mean within an order of magnitude, in some embodiments within 5-fold, and in some embodiments within 2-fold, of a value.

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A system to generate a snow cover map of complex terrain, the system comprising:
a computing device configured to:
receive from a data source, a sequence of remote sensing (RS) data regarding an environment comprising a target area where changes have occurred and a surrounding area where different surface conditions have led to contrasting response between the target area and the surrounding area,
apply a learning model to the remote sensing data to generate a map for each sequence of RS data including a spatiotemporal pattern of intermittent snow cover,
generate a snow-related parameter for the target area and the surrounding area based on the remote sensing data,
receive ground observation data of the target area, and
compare the ground observation data of the target area and the generated snow-related parameter generated from the remote sensing data.

2. The system of claim 1, wherein the snow-related parameter is a spatial representativeness of snow cover.

3. The system of claim 1, wherein the snow-related parameter is a snow depth.

4. The system of claim 1, wherein the snow-related parameter is a soil moisture.

5. The system of claim 1, wherein the computing device is further configured to generate a predicted snow melt runoff volume for the target area based on the snow-related parameter.

6. The system of claim 1, wherein the map includes the spatiotemporal pattern at near-daily, 3-m resolution.

7. The system of claim 1, wherein the remote sensing data includes CubeSat imagery or data from an unmanned aerial vehicle, a drone, an airplane, or other satellites.

8. The system of claim 1, wherein the ground observation data includes Snowtography, SNOTEL, or other in-site sensors.

9. The system of claim 1, wherein the learning model is a U-Net deep learning model.

10. The system of claim 1, wherein the computing device is configured to assess spatial representativeness by comparing point measurements to surrounding landscape variability.

11. The system of claim 1, wherein the computing device is further configured to generate snow persistence maps based on the spatiotemporal pattern of intermittent snow cover.

12. A method for generating a snow cover map of complex terrain, the method comprising:
receiving from a data source, a sequence of remote sensing (RS) data regarding an environment comprising a target area where changes have occurred and a surrounding area where different surface conditions have led to contrasting response between the target area and the surrounding area,
applying a learning model to the remote sensing data to generate a map for each sequence of remote sensing data including a spatiotemporal pattern of intermittent snow cover,
generating a snow-related parameter for the target area based on the remote sensing data,
receiving ground observation data of the target area, and
comparing the ground observation data of the target area and the generated snow-related parameter generated from the remote sensing data.

13. The method of claim 12, wherein the snow-related parameter is a spatial representativeness of snow cover.

14. The method of claim 12, wherein the snow-related parameter is either a snow depth or a soil moisture, wherein inferring snow depth provides volumetric measurements.

15. The method of claim 12, further comprising generating a predicted snow melt runoff volume for the target area based on the snow-related parameter.

16. The method of claim 12, wherein the map includes the spatiotemporal pattern at near-daily, 3-m resolution.

17. The method of claim 12, wherein the remote sensing data includes at least one selected from a group consisting of CubeSat imagery, lidar surveys, data from an unmanned aerial vehicle, a drone, an airplane, and other satellites.

18. The method of claim 12, wherein the ground observation data includes at least one selected from a group consisting of Snowtography, SNOTEL, and other in-site sensors.

19. The method of claim 12, wherein the learning model is a U-Net deep learning model, and further comprising assessing spatial representativeness by comparing point measurements to surrounding landscape variability and generating snow persistence maps based on the spatiotemporal pattern of intermittent snow cover.

20. The method of claim 12, further comprising:
generating snow persistence maps based on the spatiotemporal pattern of intermittent snow cover.
